(19) United States
(12) Patent Application Publication
(10) Pub. No.: US 2026/0176483 A1
(43) Pub. Date: Jun. 25, 2026

(54) SYSTEMS AND METHODS OF DRY BIOPRINTING WITH BIOPOLYMERS

(71) Applicant: Trustees of Tufts College, Medford, MA (US)

(72) Inventors: Fiorenzo G. Omenetto, Lexington, MA (US); Nicholas Ostrovsky-Snider, Medford, MA (US)

(21) Appl. No.: 19/418,380

(22) Filed: Dec. 12, 2025

Related U.S. Application Data
(63) Continuation of application No. PCT/US24/34332, filed on Jun. 17, 2024.
(60) Provisional application No. 63/508,810, filed on Jun. 16, 2023.
(60) Provisional application No. 63/645,566, filed on May 10, 2024.

(51) Int. Cl. C09D 11/04

(52) U.S. Cl. CPC C09D 11/04

(57) ABSTRACT

Disclosed herein is a method of laser printing including xerographic printing, printing via patterns of electrostatic charge, and/or laser printing onto a substrate with a silk fibroin particle-based toner including silk fibroin particles to produce a printed article.

### CLAIM TO PRIORITY

This application claims benefit of and is a continuation of International Patent Application No. PCT/US2024/034332 (Attorney Docket No. 2095.0614), filed Jun. 17, 2024, and entitled “SYSTEMS AND METHODS OF DRY BIOPRINTING WITH BIOPOLYMERS,” International Pub. No. WO 2024/259420, which is hereby incorporated by reference in its entirety for all purposes.

International Patent Application No. PCT/US2024/034332 relates to, incorporates by reference for all purposes, and claims priority to U.S. Application Ser. No. 63/508,810 (Attorney Docket No. 2095.0553), filed Jun. 16, 2023; and U.S. Application Ser. No. 63/645,566 (Attorney Docket No. 2095.0577), filed May 10, 2024.

### BACKGROUND

Laser printing (xerography) is an established method for making print documents. Conventional laser printing utilizes conventional polymeric materials. A need exists for laser printing techniques usable in the fabrication of next generation materials and devices.

### SUMMARY

Silk fibroin is a protein that is biocompatible, compostable, edible, optically clear, stabilizes fragile biomolecules and as was recently discovered, can be xerographically printed. This combination of attributes make it possible to reinvent laser printing by using silk-based toners to pattern biodegradable or edible packaging materials or foods themselves. It can also be used in the fabrication of medical diagnostic instruments such as printed sensors, wearables, laminar flow devices, or antibiotic-resistance test strips to simplify production and add shelf-stability to the products because of the stabilizing properties of silk. Lastly, the high degree of precision available in printing allows the imagining of future devices based on silk-xerography that enable adaptive personalized medicine.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1. Silk fibroin inks printed on A) paper and B) cellulose acetate films.

FIG. 2. Life cycle analysis of toners. (A) the linear cradle to grave life cycle of polymer based toners and (B) the circular life cycle of biodegradable toners like silk fibroin.

FIG. 3. The silk xerography process. 1) The OPC drum is uniformly charged by a charge roller, 2) the surface charge is patterned by a scanned laser, 3) the charged areas of the surface collect silk toner, 4) the toner is transferred to the substrate, 5) the toner is set by reflowing with water vapor, and 6) the toner is (optionally) made water-insoluble by high temperature vapor annealing.

FIG. 4. Silk xerography in personalized medicine. (Left) Medical printers could use a medicinal toner comprised of therapeutics encapsulated in silk fibroin microparticles could be used as a xerographic toner. This toner then doses the powder by printing defined areas on an edible film, and afterwards the film can be consumed directly or loaded into an enteric capsule. (Right) The medical printer enables dynamic redosing of medicines to meet personalized medical outcomes in a fully automated feedback loop. This loop is mediated by biomedical data that is being continuously acquired by a wearable sensor.

### DETAILED DESCRIPTION

Before the present disclosure is described in further detail, it is to be understood that the disclosure is not limited to the particular embodiments described. It is also understood that the terminology used herein is for the purpose of describing particular embodiments only, and is not intended to be limiting. The scope of the present disclosure will be limited only by the claims. As used herein, the singular forms “a”, “an”, and “the” include plural embodiments unless the context clearly dictates otherwise.

In this application, unless otherwise clear from context, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; and (iv) the terms “about” and “approximately” are used as equivalents and may be understood to permit standard variation as would be understood by those of ordinary skill in the art; and (v) where ranges are provided, endpoints are included.

Approximately: as used herein, the term “approximately” or “about,” as applied to one or more values of interest, refers to a value that is similar to a stated reference value. In certain embodiments, the term “approximately” or “about” refers to a range of values that fall within 25%, 20%, 19%, 18%, 17%, 16%, 15%, 14%, 1³%, 1²%, % 1%, 10% 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Composition: as used herein, may be used to refer to a discrete physical entity that comprises one or more specified components. In general, unless otherwise specified, a composition may be of any form—e.g., gas, gel, liquid, solid, etc. In some embodiments, “composition” may refer to a combination of two or more entities for use in a single embodiment or as part of the same article. It is not required in all embodiments that the combination of entities result in physical admixture, that is, combination as separate co-entities of each of the components of the composition is possible; however many practitioners in the field may find it advantageous to prepare a composition that is an admixture of two or more of the ingredients in a pharmaceutically acceptable carrier, diluent, or excipient, making it possible to administer the component ingredients of the combination at the same time.

Dry: as used herein, the term “dry” refers to the lack of moisture in a tactile sense, not in an absolute sense, so water that is trapped within a crystal structure can be present within dry particles. In some cases, a dry composition is free of bulk water. In general, a powder form is considered dry, so long as neighboring particles do not adhere to one another without additional components.

Improve, increase, or reduce: as used herein or grammatical equivalents thereof, indicate values that are relative to a baseline measurement, such as a measurement in a similar composition made according to previously known methods.

Substantially: as used herein, the term “substantially” refers to the qualitative condition of exhibiting total or near-total extent or degree of a characteristic or property of interest. One of ordinary skill in the biological arts will understand that biological and chemical phenomena rarely, if ever, go to completion and/or proceed to completeness or achieve or avoid an absolute result. The term “substantially” is therefore used herein to capture the potential lack of completeness inherent in many biological and chemical phenomena.

It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

As used herein, “silk fibroin” refers to silk fibroin protein whether produced by silkworm, spider, or other insect, or otherwise generated (Lucas et al., Adv. Protein Chem., 13: 107-242 (1958)). Any type of silk fibroin can be used in different embodiments described herein. Silk fibroin produced by silkworms, such as Bombyx mori, is the most common and represents an earth-friendly, renewable resource. For instance, silk fibroin used in a silk film may be attained by extracting sericin from the cocoons of B. mori. Organic silkworm cocoons are also commercially available. There are many different silks, however, including spider silk (e.g., obtained from Nephila clavipes), transgenic silks, genetically engineered silks, such as silks from bacteria, yeast, mammalian cells, transgenic animals, or transgenic plants, and variants thereof, that can be used. See, e.g., WO 97/08315 and U.S. Pat. No. 5,245,012, each of which is incorporated herein by reference in their entireties.

Wherever laser printing is articulated herein, xerographic printing and printing via patterns of electrostatic charge are expressly contemplated as being disclosed as alternatives.

Disclosed herein is an example method of laser printing including xerographic printing, printing via patterns of electrostatic charge, and/or laser printing onto a substrate with a silk fibroin particle-based toner including silk fibroin particles to produce a printed article. In the example method, the laser printing sequentially includes a first laser printing iteration with the silk fibroin particle-based toner, a first intermediate printing iteration, and a second laser printing iteration with the silk firoin particle-based toner. The laser printing can further sequentially include, following the second laser printing iteration, a second intermediate printing iteration, and a third laser printing iteration with the silk fibroin particle-based toner.

Populations of bioprinting protein particles and/or silk fibroin particles with varying properties can be generated to provide a catalog of printable resources, with pixel level control. Powders can be mixed in various proportions and deposited with unique proportions at unique pixels, thus sampling a large number of variables in a single printing process.

The printing process may enable very accurate (and adjustable) dosing of therapeutic agents to achieve certain therapeutic effects while avoiding side effects that result from too-high dosage. When paired with a continuous monitoring device, it could allow for continuously varied dosages to hit specified therapeutic targets.

The precise spatial and compositional control will allow for implementation of large-scale samplings, where multiple variables are simultaneously sampled across a variety of unique printed environments.

Dry bioprinting allows the integration of bioactive printing with the underlying paper substrate, bringing paper to life without the usual requirement of wet printing.

Dry bioprinting allows an integrated sensor to be prepared by a dry bioprinting process, where the sensing portion in the form of dried particles can be shelf-stabilized and/or inactive in a dehydrated state, extending shelf life and allowing on-demand activation of various capabilities, including but not limited to, assays, medical screening devices, combination chemistry, displays, biological displays, security tags, bio-barcodes, aesthetic articles, time-varying images with time-varying tunable colors, flavor profiles, scent profiles, biological activity, fluorescence, chemistry, and the like.

In some cases, the methods described herein can be used to print onto existing devices, such as a previously-printed device. The methods described herein can be utilized to layer biologically active systems onto existing systems. The methods described herein can be utilized to prepare layered capabilities, such as those described above.

The example method further includes printing a second biopolymer prior to or subsequent to the laser printing and/or post-processing the silk fibroin particle-based toner following the laser printing.

In the example method, the first intermediate printing iteration includes printing with a biopolymer ink including lignin, alginate, chitin, keratin, chitosan, or a combination thereof.

As described herein, an intermediate printing iteration can include the laser printing and/or dry bioprinting methods described herein or they can include other printing approaches, including conventional printing, wet printing, inkjet printing, aqueous bioprinting, combinations thereof, and the like. For the avoidance of doubt, the inventive nature of the printing can be combined with more conventional printing steps to produce complex structures that include one or more of the properties described herein as related to the laser printing and/or dry bioprinting of the disclosure.

Without wishing to be bound by any particular theory, it is believed that the printing methods described herein can be broadly applicable across multiple levels of a complex material structure, with printed articles serving as components that are assembled into a larger structure. The present disclosure provides the capability of printing unique combinations of materials by mixing particles to provide a specific chemical signature to the toner composition. The present disclosure also provides the capability of providing unique physical arrangements of the combinations of materials.

In certain cases, the methods can include printing two different toners that are incompatible with one another (e.g., reactive with one another), with physical isolation from one another and separation by one or more layers of a different material.

Disclosed herein is an example dry bioprinting process including selecting a bioprinting protein, a desired particle physical dimension, a desired particle electrostatic property, and optionally a desired particle residual moisture or a desired setting process (e.g., parameters to be utilized in a setting process), and laser printing with a bioprinting protein particle based toner onto a substrate to produce a printed article, the bioprinting protein particle based toner including bioprinting protein particles having the desired particle physical dimension, the desired particle electrostatic property, and optionally the desired particle residual moisture or the desired setting process.

In the example dry bioprinting process, the bioprinting protein is a structural protein, a globular protein, a fibrillar protein, an amphiphilic protein, or a combination thereof. The bioprinting protein is albumin, sericin, collagen, casein, gluten, keratin, zein, or silk fibroin. In specific instances, the bioprinting protein is silk fibroin.

In the example dry bioprinting process, the desired particle physical dimension is selected from a physical dimension disclosed in any one of US Pat. App. Pub. Nos. 2023/0039387 A1, 2023/0045444 A1, 2023/0051936 A1, 2023/0080900 A1, 2023/0091090 A1, 2023/0116451 A1, 2023/0117448 A1, 2023/0161277 A1, 2023/0176495 A1, Korean Patent No. 10-2517821 B1, each of which is incorporated herein in its entirety by reference for all purposes.

In the example dry bioprinting process, the desired particle physical dimension is between 1 μm and 10 μm or between 3 μm and 5 μm.

In the example dry bioprinting process, the desired particle electrostatic property is selected from an electrostatic property disclosed in any one of US Pat. App. Pub. Nos. 2023/0039387 A1, 2023/0045444 A1, 2023/0051936 A1, 2023/0080900 A1, 2023/0091090 A1, 2023/0116451 A1, 2023/0117448 A1, 2023/0161277 A1, 2023/0176495 A1, Korean Patent No. 10-2517821 B1, each of which is incorporated herein in its entirety by reference for all purposes.

In examples disclosed herein, the bioprinting protein particles or the silk fibroin particles may have certain particle physical dimensions, particle electrostatic properties, physical properties, or certain formulations for printing.

An average particle diameter of a toner matrix particle may be in the range of 4 to 10 m in median diameter on a volume basis, or may be in the range of 6 to 9 m. In some examples, a typical particle diameter of is 3 μm to 10 μm. Some example toners have an average particle diameter of 7 m.

For some example toners, an average circularity, calculated from the formula (Circularity=Perimeter of circle calculated from the circle equivalent diameter/Perimeter of projected image of particles), may be in the range of 0.930 to 1.000, or may be in the range of 0.950 to 0.995, or in the range of 0.94 to 0.99, or in the range of 0.97 to 0.99, or in the range from 0.920 to 0.965, or in the range from 0.940 to 0.962, or in the range from 0.945 to 0.955.

An example toner formulation may include toner particles that contain a binder resin and a coloring agent is used as the toner. Another example formulation includes a toner particle including a toner base particle containing a binder resin and a protruded portion on a surface of the toner base particle; the protruded portion including an organosilicon polymer and a polyhydric acid metal salt; and the polyhydric acid metal salt is present on a surface of the protruded portion. Yet another example formulation includes a toner particle containing a binder resin, and an external additive; the toner particle has at least one multivalent metal element selected from the group consisting of aluminum, magnesium, calcium and iron. Still another example formulation includes a toner particle including a binder resin and an ester compound, wherein: the binder resin comprises a resin A comprising a specific amount of a long-chain acrylate unit and a styrene-based monomer unit, and a resin B comprising a specific monomer unit in a specific amount; the ester compound has an alkyl chain with a specific chain length. In yet another formulation, an example polymerized toner includes a binder resin, and toner particles including a pigment or carbon black dispersed in the binder resin, a charge control agent, and a wax.

Some example toners have a Martens hardness of 200 MPa or more and 1100 MPa or less as measured at a maximum load of 2.0×10−⁴ [N].

An example toner has a loss elastic modulus G” at 100° C. of preferably not more than 3.0×10⁵ (dyn/cm²) or not more than 7.0×10⁴ (dyn/cm²), with a lower limit greater than or equal to 2.0×10⁴ (dyn/cm²) or 4.0×10⁴ (dyn/cm²).

In the example dry bioprinting process, the desired electrostatic property is dielectric.

In the example dry bioprinting process, the desired residual moisture is 20% or less, 15% or less, or 10% or less.

Disclosed herein is an example dry bioprinting process including administering a bioprinting protein particle-based toner comprising bioprinting protein particles to a substrate, and sintering the bioprinting protein particles.

In the example dry bioprinting process, the bioprinting protein is a structural protein, a globular protein, a fibrillar protein, an amphiphilic protein, or a combination thereof. The bioprinting protein is silk fibroin.

In some cases, the bioprinting protein particles and/or the silk fibroin particles can be non-porous. In some cases, the bioprinting protein particles and/or the silk fibroin particles can be monolithic.

In the example dry bioprinting process, the administering forms an image and the sintering sets the image. In the example dry bioprinting process, the administering includes xerography.

In the example dry bioprinting process, the sintering includes contacting the bioprinting protein particles with water vapor. Sintering includes contacting the bioprinting protein particles with water vapor at two different water vapor temperatures. Contacting the bioprinting protein particles with water vapor includes maintaining the bioprinting protein particles and the water vapor at a temperature of less than 75° C., less than 70° C., less than 65° C., less than 60° C., less than 55° C., or less than 50° C.

Disclosed herein is an example silk fibroin particle-based toner including silk fibroin particles.

Disclosed herein is an example laser printing cartridge loaded with silk fibroin particle-based toner including silk fibroin particles.

The disclosed methods, processes, particles, and/or cartridges can include post-processing, as would be appreciated by a person having ordinary skill in the art. Post-processing can involve a setting and/or sintering process, which may depend on the substrate. Post-processing can involve a curing, crosslinking, and/or recrystallizing process, which may depend on the substrate. In some cases, the setting and/or sintering can be achieved in the same basic process steps as the curing, crosslinking and/or recrystallizing.

Without wishing to be bound by any particular theory, it is believed that water vapor reflow is a process that encompasses setting and/or sintering. Water vapor reflow can be achieved by contacting particles with water vapor for seconds at a temperature from room temperature up to 90° C.

Without wishing to be bound by any particular theory, it is believed that annealing is a process that encompasses curing, crosslinking, and/or recrystallizing. Annealing can be achieved by exposing particles to water vapor at elevated temperatures. For example, the annealing process is explained in detail in Hu et al. “Regulation of Silk Material Structure by Temperature-Controlled Water Vapor Annealing”, Biomacromolecules 2011, 12, 1686-1696, which is incorporated herein in its entirety by reference. Without being limiting, annealing of particles can be achieved within 5 minutes with exposure to 100% relative humidity at 45° C., can be achieved within seconds using steam above 100° C., or other conditions as would be appreciated by a skilled artisan.

In some cases, any of the methods or process described herein, or the products used in methods, can include setting and/or sintering. In some cases, any of the methods or process described herein, or the products used in methods, can include curing, crosslinking, and/or recrystallizing. In some cases, the setting and/or sintering is separate and distinct from the curing, crosslinking, and/or recrystallizing. In some cases, the setting and/or sintering is achieved using the same basic method steps as the curing, crosslinking, and/or recrystallizing.

In the example methods, processes, particles, or cartridges disclosed herein, the silk fibroin particle-based toner further includes filler fine particles. In some examples, the filler fine particles include inorganic fine particles. The inorganic fine particles include silica, titania, alumina, or a combination thereof. In some examples, the filler fine particles include organic fine particles. In some examples, the filler fine particles include organic-inorganic composite fine particles.

In the example methods, processes, particles, or cartridges disclosed herein, a number average particle diameter of the silk fibroin particles is 20 nm or more and 1000 μm or less, including but not limited to, 1 μm or more and 10 μm or less, or 3 μm or more and 5 μm or less.

In the example methods, processes, particles, or cartridges disclosed herein, the silk fibroin particles have one or more physical properties or physical dimensions, have one or more electrostatic properties, or are formulated for printing as recited in any one of US Pat. App. Pub. Nos. 2023/0039387 A1, 2023/0045444 A1, 2023/0051936 A1, 2023/0080900 A1, 2023/0091090 A1, 2023/0116451 A1, 2023/0117448 A1, 2023/0161277 A1, 2023/0176495 A1, Korean Patent No. 10-2517821 B1, each of which is incorporated herein in its entirety by reference for all purposes.

In the example methods, processes, particles, or cartridges disclosed herein, the silk fibroin particles further include an additive.

In the example methods, processes, particles, or cartridges disclosed herein, the silk fibroin particles include a functional additive, wherein the functional additive is a selective protein, a fluorophore, a conductive material, a thermoreactive material, a sensing additive, a biologically active agent, or the like.

In the example methods, processes, particles, or cartridges disclosed herein, the silk fibroin particles include a medical diagnostic additive.

In the example methods, processes, particles, or cartridges disclosed herein, a functional additive is covalently linked to the silk fibroin. In the example methods, processes, particles, or cartridges disclosed herein, the silk fibroin particles and/or the bioprinting protein particles include one or more nutritional supplements. The functional additive is mixed with the silk fibroin within the silk fibroin particles.

In the example methods, processes, particles, or cartridges disclosed herein, the silk fibroin particles include a non-functional additive, wherein the non-functional additive is a non-selective protein, a colorant (e.g., a dye), an opacifying agent, an iridescent agent, a flavorant, an aroma, or the like.

In the example methods, processes, particles, or cartridges disclosed herein, the silk particles include a colorant, wherein the colorant is optionally a dye. The colorant is a naturally-occurring colorant, wherein the colorant is optionally anthocyanin.

In the example methods, processes, particles, or cartridges disclosed herein, the silk fibroin particles include silk fibroin that is at least partly sourced from recycled silk fabric.

In the example methods, processes, particles, or cartridges disclosed herein, the silk fibroin particles are made by spray drying.

In the example methods, processes, particles, or cartridges disclosed herein, the silk fibroin particles are made by powdering or lyophilization.

In the example methods, processes, particles, or cartridges disclosed herein, the silk fibroin particles have a beta-sheet crystallinity degree of greater than 50% of a maximum achievable beta-sheet crystallinity degree. In some cases, the silk fibroin particles have a beta-sheet crystallinity of greater than 60%, greater than 70%, greater than 80%, or greater than 90% of a maximum achievable beta sheet crystallinity. In some cases, the silk fibroin particles have the maximum achievable beta sheet crystallinity.

In the example methods, processes, particles, or cartridges disclosed herein, the silk fibroin particles have a beta-sheet crystallinity degree of less than 50% of a maximum achievable beta-sheet crystallinity degree. In some cases, the silk fibroin particles have a beta-sheet crystallinity of less than 40%, less than 30%, less than 25%, less than 20%, less than 15%, less than 10%, or less than 5% or a maximum achievable beta-sheet crystallinity. In some cases, the silk fibroin particles have 0% of the maximum achievable beta-sheet crystallinity.

In the example methods, processes, particles, or cartridges disclosed herein, the silk fibroin particles have a minimum achievable beta-sheet crystallinity degree.

In the example methods, processes, particles, or cartridges disclosed herein, the substrate is a paper, a biodegradable substrate, or an edible substrate. Without wishing to be bound by any particular theory, it is believed that the disclosed methods may have advantages in printing onto biodegradable substrates and/or edible substrates.

In some cases, the substrate is conventional paper, a clear sheet, or the like. In some cases, the substrate is cellulose paper. In some cases, the substrate is cellulose acetate.

In the example methods, processes, particles, or cartridges disclosed herein, the substrate includes silk fibroin.

In the example methods and/or processes, the method and/or process includes sintering (or setting/water vapor reflowing) the silk fibroin particles and/or the bioprinting protein particles. Sintering can include contacting the silk fibroin particles and/or the bioprinting protein particles with water vapor. Sintering can include applying heat to the silk fibroin particles and/or the bioprinting protein particles. Applying heat can include a temperature of at least 30° C., at least 35° C., at least 40° C., at least 45° C., at least 50° C., at least 55° C., at least 60° C., at least 65° C., at least 70° C., at least 75° C., at least 80° C., at least 85° C., at least 90° C., or at least 95° C. and optionally at most 100° C. Sintering can include administering a protease, applying pressure, or applying heat and pressure to the silk fibroin particles and/or the bioprinting protein particles.

In the example methods and/or processes, the method and/or process includes annealing (or curing/crosslinking/recrystallizing) the silk fibroin particles and/or the bioprinting protein particles. The annealing can include applying higher humidities and/or higher temperatures and/or longer exposures than the sintering/setting/water vapor reflow step.

In the example methods and/or processes, the method and/or process includes simultaneously setting (sintering/water vapor reflowing) and annealing (curing/crosslinking/recrystallizing) the silk fibroin particles and/or the bioprinting protein particles.

In the example methods and/or process, the method can include post-processing of contacting the silk fibroin particles and/or the bioprinting protein particles with water vapor.

In the example methods and/or process, the method can include post-processing of applying elevated temperature the silk fibroin particles and/or the bioprinting protein particles with water vapor.

In the example methods and/or process, the method can include post-processing of contacting the silk fibroin particles and/or the bioprinting protein particles with water vapor at elevated temperature.

The relative humidity of the water vapor can be at least 25%, at least 30%, at least 40%, at least 50%, at least 60%, at least 70%, at least 75%, at least 80%, at least 85%, at least 90%, at least 95%, or approximately 100%.

The elevated temperature of the water vapor can be at least 30° C., at least 35° C., at least 40° C., at least 45° C., at least 50° C., at least 55° C., at least 60° C., at least 65° C., at least 70° C., at least 75° C., at least 80° C., at least 85° C., at least 90° C., or at least 95° C. The elevated temperature of the water vapor can be at least 100° C. or higher.

A skilled artisan will recognize that relative humidity, temperature, and exposure time can be adjusted to achieve a desired setting and optionally annealing process.

In some cases, the methods and/or processes can result in a printed article that has silk fibroin particles that have amorphous crystallinity. Without wishing to be bound by any particular theory, it is believed that a printing process that retains silk fibroin particles with amorphous crystallinity can have some advantages when it comes to particular applications. In some cases, the final printed article has silk fibroin particles with minimum achievable beta sheet crystallinity.

In some cases, the methods and/or process can result in a printed article that has silk fibroin particles with significant beta sheet crystallinity. Without wishing to be bound by any particular theory, it is believed that a printing process that maximizes the beta sheet crystallinity in silk fibroin particles can have some advantages when it comes to particular applications. In some cases, the final printed article has silk fibroin particles with maximum achievable beta sheet crystallinity.

In the example methods and/or processes, the method further includes activating the silk fibroin particle based toner and/or the bioprinting protein particle based toner by hydrating the silk fibroin particles and/or the bioprinting protein particles. At least one property of the silk fibroin particle based toner and/or the bioprinting protein particle based toner is changed by the activating.

In examples, the laser printing and/or dry bioprinting generates a personalized drug discovery platform.

In examples, the laser printing and/or dry bioprinting generates a spatially-varying sensing platform, a conductive pathway, or light-emitting compounds.

In examples, the laser printing and/or dry bioprinting includes one or more lasing media, one or more conductive molecules, one or more photoconducting materials (e.g., perovskites), or a natural dye (e.g., anthocyanin).

In examples, the printed article includes a physically unclonable function.

Physically unclonable functions (PUFs) are cryptographic tools that exploit the inherent randomness of various physical fabrication processes to make unique object identifiers that are easy to fabricate but exceptionally difficult to reproduce. A classical example of a PUF is glitter embedded in clear polymer resin. The fabrication of such an object is trivial, but each contains an exceptionally high number of degrees of freedom. Patterns of colors, the reflectivity at various angles of illumination and other properties are easily measured for any individually created piece but would be extraordinarily difficult to reproduce exactly. Thus, each piece acts as a unique identifier that cannot be readily copied by a counterfeiter.

Electrostatic silk printing is well suited to fabricating PUFs thanks to the inherent randomness of the shape and distribution of toner particulate and the ease of loading active cargo into the toner. Silk toner is fabricated by a grinding process giving a distribution of sizes and shapes to the toner particles that can be readily viewed under a microscope. The distribution of these shapes has the high degree of freedom needed for simple PUFs. Recently active PUFs have been created with challenge-response pairing, adding yet more degrees of freedom and further complicating duplication. These include optical responses (structural color, fluorescence, up-conversion, random lasing, thermochromics, plasmonics, etc.), chemical responses (pH, enzyme catalyzed reactions, affinity-pairs, etc), and physical responses (patterned magnetism, etc), all of which can be readily loaded into the silk during the formulation process. Lastly, silk is entirely biocompatible and edible, opening the use of these PUFs on medical implants and high-value pharmaceuticals.

According to various embodiments, a variety of functionalizing agents may be used with the silk-containing embodiments described herein (e.g., silk membrane, silk composition, silk matrix, silk foam, silk microsphere, silk powder, silk toner, etc.). It should be understood that the examples herein may recite one or a few silk-containing embodiments but are applicable to any silk-containing embodiment, as applicable. In some embodiments, a functionalizing agent may be any compound or molecule that facilitates the attachment to and/or development (e.g., growth) of one or more endothelial cells on a silk membrane. In some embodiments, a functionalizing agent may be any compound or molecule that facilitates the attachment and/or development (e.g., growth) of one or more megakaryocytes and/or hematopoietic progenitor cells on a silk matrix and/or silk membrane. In some embodiments, a functionalizing agent may be or comprise an agent suitable for facilitating the production of one or more of white blood cells and red blood cells.

In some embodiments, a functionalizing agent may be or comprise a cell attachment mediator and/or an extracellular matrix protein, for example: collagen (e.g., collagen type I, collagen type III, collagen type IV or collagen type VI), elastin, fibronectin, vitronectin, laminin, fibrinogen, von Willebrand factor, proteoglycans, decorin, perlecan, nidogen, hyaluronan, and/or peptides containing known integrin binding domains e.g. “RGD” integrin binding sequence, or variations thereof, that are known to affect cellular attachment.

In some embodiments, a functionalizing agent may be any soluble molecule produced by endothelial cells. Non-limiting examples include fibroblast growth factor-1 (FGF1) and vascular endothelial growth factors (VEGF).

According to some embodiments, a plurality of functionalizing agents may be used. For example, in some embodiments wherein production of platelets is desired, provided compositions may comprise the use of laminin, fibronectin and/or fibrinogen, and type IV collagen in order to facilitate the attachment and growth of endothelial cells on a silk membrane (e.g., a porous silk membrane) and/or attachment of megakaryocytes to a silk matrix.

In some embodiments, a functionalizing agent may be embedded or otherwise associated with a silk membrane and/or silk matrix such that at least a portion of the functionalizing agent is surrounded by a silk membrane and/or silk matrix as contrasted to a functionalizing agent simply being positioned along the surface of a silk membrane and/or silk matrix. In some embodiments, a functionalizing agent is distributed along and/or incorporated in substantially the entire surface area of a silk membrane/silk wall. In some embodiments, a functionalizing agent is distributed and/or incorporated only at one or more discrete portions of a silk membrane/wall and/or silk matrix. In some embodiments, a functionalizing agent is distributed in and/or along at least one of the lumen-facing side of a silk wall and the matrix-facing side of a silk wall.

According to various embodiments, any application-appropriate amount of one or more functionalizing agents may be used. In some embodiments, the amount of an individual functionalizing agent may be between about 1 g/ml and 1,000 g/ml (e.g., between about 2 and 1,000, 5 and 1,000, 10 and 1,000, 10 and 500, 10 and 100 g/ml). In some embodiments, the amount of an individual functionalizing agent may be at least 1 g/ml (e.g., at least 5, 10, 15, 20 25, 50, 100, 200, 300 400, 500, 600, 700, 800, or 900 g/ml). In some embodiments, the amount of an individual functionalizing agent is at most 1,000 g/ml (e.g., 900, 800, 700, 600, 500, 400, 300 200, 100, 90, 80, 70, 60, 50, 40, 30, 20, 10, or 5 g/ml).

In some aspects, the composition comprises one or more sensing agents, such as a sensing dye. The sensing agents/sensing dyes are environmentally sensitive and produce a measurable response to one or more environmental factors. In some aspects, the environmentally-sensitive agent or dye may be present in the composition in an effective amount to alter the composition from a first chemical-physical state to a second chemical-physical state in response to an environmental parameter (e.g., a change in pH, light intensity or exposure, temperature, pressure or strain, voltage, physiological parameter of a subject, and/or concentration of chemical species in the surrounding environment) or an externally applied stimulus (e.g., optical interrogation, acoustic interrogation, and/or applied heat). In some cases, the sensing dye is present to provide one optical appearance under one given set of environmental conditions and a second, different optical appearance under a different given set of environmental conditions. Suitable concentrations for the sensing agents described herein can be the concentrations for the colorants and additives described elsewhere herein. A person having ordinary skill in the chemical sensing arts can determine a concentration that is appropriate for use in a sensing application of the inks described herein.

In some aspects, the first and second chemical-physical state may be a physical property of the composition, such as mechanical property, a chemical property, an acoustical property, an electrical property, a magnetic property, an optical property, a thermal property, a radiological property, or an organoleptic property. Exemplary sensing dyes or agents include, but are not limited to, a pH sensitive agent, a thermal sensitive agent, a pressure or strain sensitive agent, a light sensitive agent, or a potentiometric agent.

Exemplary pH sensitive dyes or agents include, but are not limited to, cresol red, methyl violet, crystal violet, ethyl violet, malachite green, methyl green, 2-(p-dimethylaminophenylazo) pyridine, paramethyl red, metanil yellow, 4-phenylazodiphenylamine, thymol blue, metacresol purple, orange IV, 4-o-Tolylazo-o-toluindine, quinaldine red, 2,4-dinitrophenol, erythrosine disodium salt, benzopurpurine 4B, N,N-dimethyl-p-(m-tolylazo) aniline, p-dimethylaminoazobenene, 4,4′-bis(2-amino-1-naphthylazo)-2,2′-stilbenedisulfonic acid, tetrabromophenolphthalein ethyl ester, bromophenol blue, Congo red, methyl orange, ethyl orange, 4-(4-dimethylamino-1-naphylazo)-3-methoxybenesulfonic acid, bromocresol green, resazurin, 4-phenylazo-1-napthylamine, ethyl red 2-(1-dimethylaminophenyazo) pyridine, 4-(p-ethoxypehnylazo)-m-phenylene-diamine monohydrochloride, resorcin blue, alizarin red S, methyl red, propyl red, bromocresol purple, chlorophenol red, p-nitrophenol, alizarin 2-(2,4-dinitrophenylazo) 1-napthol-3,6-disulfonic acid, bromothymol blue, 6,8-dinitro-2,4-(1H) quinazolinedione, brilliant yellow, phenol red, neutral red, m-nitrophenol, cresol red, turmeric, metacresol purple, 4,4′-bis(3-amino-1-naphthylazo)-2,2′-stilbenedisulfonic acid, thymol blue, p-naphtholbenzein, phenolphthalein, o-cresolphthalein, ethyl bis(2,4-dimethylphenyl) ethanoate, thymolphthalein, nitrazine yellow, alizarin yellow R, alizarin, p-(2,4-dihydroxyphenylazo) benzenesulfonic acid, 5,5′-indigodisulfonic acid, 2,4,6-trinitrotoluene, 1,3,5-trinitrobenezne, and clayton yellow.

Exemplary light responsive dyes or agents include, but are not limited to, photochromic compounds or agents, such as triarylmethanes, stilbenes, azasilbenes, nitrones, fulgides, spiropyrans, napthopyrans, spiro-oxzines, quinones, derivatives and combinations thereof.

Exemplary potentiometric dyes include, but are not limited to, substituted amiononaphthylehenylpridinium (ANEP) dyes, such as di-4-ANEPPS, di-8-ANEPPS, and N-(4-Sulfobutyl)-4-(6-(4-(Dibutylamino)phenyl)hexatrienyl)Pyridinium (RH237).

Exemplary temperature sensitive dyes or agents include, but are not limited to, thermochromic compounds or agents, such as thermochromic liquid crystals, leuco dyes, fluoran dyes, octadecylphosphonic acid.

Exemplary pressure or strain sensitive dyes or agents include, but are not limited to, spiropyran compounds and agents.

Exemplary chemi-sensitive dyes or agents include, but are not limited to, antibodies such as immunoglobulin G (IgG) which may change color from blue to red in response to bacterial contamination.

In some aspects, the compositions comprise one or more additive, dopant, or biologically active agent suitable for a desired intended purpose. In some aspects, the additive or dopant may be present in the composition in an amount effective to impart an optical or organoleptic property to the composition. Exemplary additives or dopants that impart optical or organoleptic properties include, but are not limited to, dyes/pigments, flavorants, aroma compounds, granular or fibrous fillers.

Additionally or alternatively, the additive, dopant, or biologically active agent may be present in the composition in an amount effective to “functionalize” the composition to impart a desired mechanical property or added functionality to the composition. Exemplary additive, dopants, or biologically active agent that impart the desired mechanical property or added functionality include, but are not limited to: environmentally sensitive/sensing dyes; active biomolecules; conductive or metallic particles; micro and nanofibers (e.g., silk nanofibers for reinforcement, carbon nanofibers); nanotubes; inorganic particles (e.g., hydroxyapatite, tricalcium phosphate, bioglasses); drugs (e.g., antibiotics, small molecules or low molecular weight organic compounds); proteins and fragments or complexes thereof (e.g., enzymes, antigens, antibodies and antigen-binding fragments thereof); DNA/RNA (e.g., siRNA, miRNA, mRNA); cells and fractions thereof (viruses and viral particles; prokaryotic cells such as bacteria; eukaryotic cells such as mammalian cells and plant cells; fungi).

In some aspects, the additive or dopant comprises a flavoring agent or flavorant.

Exemplary flavorants include ester flavorants, amino acid flavorants, nucleic acid flavorants, organic acid flavorants, and inorganic acid flavorants, such as, but not limited to, diacetyl, acetylpropionyl, acetoin, isoamyl acetate, benzaldehyde, cinnamaldehyde, ethyl propionate, methyl anthranilate, limonene, ethyl decadienoate, allyl hexanoate, ethyl maltol, ethylvanillin, methyl salicylate, manzanate, glutamic acid salts, glycine salts, guanylic acids salts, inosinic acid salts, acetic acid, ascorbic acid, citric acid, fumaric acid, lactic acid, malic acid, phosphoric acid, tartaric acid, derivatives, and mixtures thereof.

In some aspects, the additive or dopant comprises an aroma compound. Exemplary aroma compounds include ester aroma compounds, terpene aroma compounds, cyclic terpenes, and aromatic aroma compounds, such as, but not limited to, geranyl acetate, methyl formate, methyl acetate, methyl propionate, methyl butyrate, ethyl acetate, ethyl butyrate, isoamyl acetate, pentyl butrate, pentyl pentanoate, octyl acetate, benzyl acetate, methyl anthranilate, myrecene, geraniol, nerol, citral, cironellal, cironellol, linalool, nerolidol, limonene, camphor, menthol, carone, terpineol, alpha-lonone, thujone, eucalyptol, benzaldehyde, eugenol, cinnamaldehyde, ethyl maltol, vanillin, anisole, anethole, estragole, thymol.

In some aspects, the additive or dopant comprises a colorant, such as a dye or pigment. In some aspects, the dye or pigment imparts a color or grayscale to the composition. The colorant can be different than the sensing agents and/or sensing dyes below. Any organic and/or inorganic pigments and dyes can be included in the inks. Exemplary pigments suitable for use in the present disclosure include International Color Index or C.I. Pigment Black Numbers 1, 7, 1 1 and 31, C.I. Pigment Blue Numbers 15, 15:1, 15:2, 15:3, 15:4, 15:6, 16, 27, 29, 61 and 62, C.I. Pigment Green Numbers 7, 17, 18 and 36, C.I. Pigment Orange Numbers 5, 13, 16, 34 and 36, C.I. Pigment Violet Numbers 3, 19, 23 and 27, C.I. Pigment Red Numbers 3, 17, 22, 23, 48:1, 48:2, 57:1, 81:1, 81:2, 81:3, 81:5, 101, 1 14, 122, 144, 146, 170, 176, 179, 181, 185, 188, 202, 206, 207, 210 and 249, C.I. Pigment Yellow Numbers 1, 2, 3, 12, 13, 14, 17, 42, 65, 73, 74, 75, 83, 30, 93, 109, 1 10, 128, 138, 139, 147, 142, 151, 154 and 180, D&C Red No. 7, D&C Red No. 6 and D&C Red No. 34, carbon black pigment (such as Regal 330, Cabot Corporation), quinacridone pigments (Quinacridone Magenta (228-0122), available from Sun Chemical Corporation, Fort Lee, N.J.), diarylide yellow pigment (such as AAOT Yellow (274-1788) available from Sun Chemical Corporation); and phthalocyanine blue pigment (such as Blue 15:3 (294-1298) available from Sun Chemical Corporation). The classes of dyes suitable for use in present invention can be selected from acid dyes, natural dyes, direct dyes (either cationic or anionic), basic dyes, and reactive dyes. The acid dyes, also regarded as anionic dyes, are soluble in water and mainly insoluble in organic solvents and are selected, from yellow acid dyes, orange acid dyes, red acid dyes, violet acid dyes, blue acid dyes, green acid dyes, and black acid dyes. European Patent 0745651, incorporated herein by reference, describes a number of acid dyes that are suitable for use in the present disclosure. Exemplary yellow acid dyes include Acid Yellow 1 International Color Index or C.I. 10316); Acid Yellow 7 (C.I. 56295); Acid Yellow 17 (C.I. 18965); Acid Yellow 23 (C.I. 19140); Acid Yellow 29 (C.I. 18900); Acid Yellow 36 (C.I. 13065); Acid Yellow 42 (C.I. 22910); Acid Yellow 73 (C.I. 45350); Acid Yellow 99 (C.I. 13908); Acid Yellow 194; and Food Yellow 3 (C.I. 15985). Exemplary orange acid dyes include Acid Orange 1 (C.I. 13090/1); Acid Orange 10 (C.I. 16230); Acid Orange 20 (C.I. 14603); Acid Orange 76 (C.I. 18870); Acid Orange 142; Food Orange 2 (C.I. 15980); and Orange B.

Exemplary red acid dyes include Acid Red 1. (C.I. 18050); Acid Red 4 (C.I. 14710); Acid Red 18 (C.I. 16255), Acid Red 26 (C.I. 16150); Acid Red 2.7 (C.I. as Acid Red 51 (C.I. 45430, available from BASF Corporation, Mt. Olive, N.J.) Acid Red 52 (C.I. 45100); Acid Red 73 (C.I. 27290); Acid Red 87 (C. I. 45380); Acid Red 94 (C.I. 45440) Acid Red 194; and Food Red 1 (C.I. 14700). Exemplary violet acid dyes include Acid Violet 7 (C.I. 18055); and Acid Violet 49 (C.I. 42640). Exemplary blue acid dyes include Acid Blue 1 (C.I. 42045); Acid Blue 9 (C.I. 42090); Acid Blue 22 (C.I. 42755); Acid Blue 74 (C.I. 73015); Acid Blue 93 (C.I. 42780); and Acid Blue 158A (C.I. 15050). Exemplary green acid dyes include Acid Green 1 (C.I. 10028); Acid Green 3 (C.I. 42085); Acid Green 5 (C.I. 42095); Acid Green 26 (C.I. 44025); and Food Green 3 (C.I. 42053). Exemplary black acid dyes include Acid Black 1 (C.I. 20470); Acid Black 194 (Basantol® X80, available from BASF Corporation, an azo/l:2 CR-complex.

Exemplary direct dyes for use in the present disclosure include Direct Blue 86 (C.I. 74180); Direct Blue 199; Direct Black 168; Direct Red 253; and Direct Yellow 107/132 (C.I. Not Assigned).

Exemplary natural dyes for use in the present disclosure include Alkanet (C.I. 75520,75530); Annafto (C.I. 75120); Carotene (C.I. 75130); Chestnut; Cochineal (C.I. 75470); Cutch (C.I. 75250, 75260); Divi-Divi; Fustic (C.I. 75240); Hypernic (C.I. 75280); Logwood (C.I. 75200); Osage Orange (C.I. 75660); Paprika; Quercitron (C.I. 75720); Sanrou (C.I. 75100); Sandal Wood (C.I. 75510, 75540, 75550, 75560); Sumac; and Tumeric (C.I. 75300). Exemplary reactive dyes for use in the present disclosure include Reactive Yellow 37 (monoazo dye); Reactive Black 31 (disazo dye); Reactive Blue 77 (phthalo cyanine dye) and Reactive Red 180 and Reactive Red 108 dyes. Suitable also are the colorants described in The Printing Ink Manual (5th ed., Leach et al. eds. (2007), pages 289-299. Other organic and inorganic pigments and dyes and combinations thereof can be used to achieve the colors desired.

In addition to or in place of visible colorants, compositions provided herein can contain ETV fluorophores that are excited in the ETV range and emit light at a higher wavelength (typically 400 nm and above). Examples of ETV fluorophores include but are not limited to materials from the coumarin, benzoxazole, rhodamine, napthalimide, perylene, benzanthrones, benzoxanthones or benzothia-xanthones families. The addition of a UV fluorophore (such as an optical brightener for instance) can help maintain maximum visible light transmission. The amount of colorant, when present, generally is between 0.05% to 5% or between 0.1% and 1% based on the weight of the composition.

For non-white compositions, the amount of pigment/dye generally is present in an amount of from at or about 0.1 wt % to at or about 20 wt % based on the weight of the composition. In some applications, a non-white ink can include 15 wt % or less pigment/dye, or 10 wt % or less pigment/dye or 5 wt % pigment/dye, or 1 wt % pigment/dye based on the weight of the composition. In some applications, a non-white ink can include 1 wt % to 10 wt %, or 5 wt % to 15 wt %, or 10 wt % to 20 wt % pigment/dye based on the weight of the composition. In some applications, a non-white ink can contain an amount of dye/pigment that is 1 wt %, 2 wt %, 3 wt %, 4 wt %, 5%, 6 wt %, 7 wt %, 8 wt %, 9 wt %, 10 wt %, 11 wt %, 12 wt %, 13 wt %, 14 wt %, 15%, 16 wt %, 17 wt %, 18 wt %, 19 wt % or 20 wt % based on the weight of the composition.

For white compositions, the amount of white pigment generally is present in an amount of from at or about 1 wt % to at or about 60 wt % based on the weight of the composition. In some applications, greater than 60 wt % white pigment can be present. Preferred white pigments include titanium dioxide (anatase and rutile), zinc oxide, lithopone (calcined coprecipitate of barium sulfate and zinc sulfide), zinc sulfide, blanc fixe and alumina hydrate and combinations thereof, although any of these can be combined with calcium carbonate. In some applications, a white ink can include 60 wt % or less white pigment, or 55 wt % or less white pigment, or 50 wt % white pigment, or 45 wt % white pigment, or 40 wt % white pigment, or 35 wt % white pigment, or 30 wt % white pigment, or 25 wt % white pigment, or 20 wt % white pigment, or 15 wt % white pigment, or 10 wt % white pigment, based on the weight of the composition. In some applications, a white ink can include 5 wt % to 60 wt %, or 5 wt % to 55 wt %, or 10 wt % to 50 wt %, or 10 wt % to 25 wt %, or 25 wt % to 50 wt %, or 5 wt % to 15 wt %, or 40 wt % to 60 wt % white pigment based on the weight of the composition. In some applications, a non-white ink can an amount of dye/pigment that is 5%, 6 wt %, 7 wt % 8 wt % 9 wt % 10 wt %, 11 wt %, 12 wt %, 13 wt %, 14 wt %, 15%, 16 wt %, 17 wt %, 18 wt %, 19 wt %, 20 wt %, 21 wt %, 22 wt %, 23 wt %, 24 wt %, 25%, 26 wt %, 27 wt %, 28 wt %, 29 wt %, 30 wt % 31 wt % 32 wt % 33 wt % 34 wt %, 35%, 36 wt % 37 wt %, 38 wt % 39 wt % 40 wt % 41 wt % 42 wt %, 43 wt %, 44 wt %, 45%, 46 wt %, 47 wt %, 48 wt %, 49 wt %, 50 wt %, 51 wt %, 52 wt %, 53 wt %, 54 wt %, 55%, 56 wt %, 57 wt %, 58 wt %, 59 wt % or 60 wt % based on the weight of the composition.

In some aspects, the additive or dopant comprises a conductive additive. Exemplary conductive additives include, but are not limited to graphite, graphite powder, carbon nanotubes, and metallic particles or nanoparticles, such as gold nanoparticles. In some aspects, the conductive additive is biocompatible and non-toxic.

In some aspects, the additive is a biologically active agent. The term “biologically active agent” as used herein refers to any molecule which exerts at least one biological effect in vivo. For example, the biologically active agent can be a therapeutic agent to treat or prevent a disease state or condition in a subject. Biologically active agents include, without limitation, organic molecules, inorganic materials, proteins, peptides, nucleic acids (e.g., genes, gene fragments, gene regulatory sequences, and antisense molecules), nucleoproteins, polysaccharides, glycoproteins, and lipoproteins. Classes of biologically active compounds that can be incorporated into the composition provided herein include, without limitation, anticancer agents, antibiotics, analgesics, anti-inflammatory agents, immunosuppressants, enzyme inhibitors, antihistamines, anti-convulsants, hormones, muscle relaxants, antispasmodics, ophthalmic agents, prostaglandins, anti-depressants, anti-psychotic substances, trophic factors, osteoinductive proteins, growth factors, and vaccines.

The term “active agent” may also be used herein to refer to a biological sample (e.g., a sample of tissue or fluid, such as for instance blood) or a component thereof, and/or to a biologically active entity or compound, and/or to a structurally or functionally labile entity.

Exemplary active agents include, but are not limited to, therapeutic agents, diagnostic agents (e.g., contrast agents), and any combinations thereof. In some embodiments, the active agent present in a silk matrix (e.g., a silk microsphere), composition, or the like can include a labile active agent, e.g., an agent that can undergo chemical, physical, or biological change, degradation and/or deactivation after exposure to a specified condition, e.g., high temperatures, high humidity, light exposure, and any combinations thereof. In some embodiments, the active agent present in the silk matrix (e.g., a silk microsphere), composition, or the like can include a temperature-sensitive active agent, e.g., an active agent that will lose at least about 30% or more, of its original activity or bioactivity, upon exposure to a temperature of at least about 10° C. or above, including at least about 15° C. or above, at least about room temperature or above, or at least about body temperature (e.g., about 370° C.) or above.

The active agent can be generally present in the silk matrix (e.g., a silk microsphere), composition, or the like in an amount of about 0.01% (w/w) to about 70% (w/w), or about 0.1% (w/w) to about 50% (w/w), or about 1% (w/w) to about 30% (w/w). The active agent can be present on a surface of the silk matrix (e.g., a silk microsphere), composition, or the like and/or encapsulated and dispersed in the silk matrix (e.g., a silk microsphere), composition, or the like homogeneously or heterogeneously or in a gradient. In some embodiments, the active agent can be added into the silk solution, which is then subjected to the methods described herein for preparing a silk matrix (e.g., a silk microsphere), composition, or the like. In some embodiments, the active agent can be coated on a surface of the silk matrix (e.g., a silk microsphere), composition, or the like. In some embodiments, the active agent can be loaded in a silk matrix (e.g., a silk microsphere), composition, or the like by incubating the silk microsphere in a solution of the active agent for a period of time, during which an amount of the active agent can diffuse into the silk matrix (e.g., a silk microsphere), composition, or the like, and thus distribute within the silk matrix (e.g., a silk microsphere), composition, or the like.

In some aspects, the additive is a therapeutic agent. As used herein, the term “therapeutic agent” means a molecule, group of molecules, complex or substance administered to an organism for diagnostic, therapeutic, preventative medical, or veterinary purposes. As used herein, the term “therapeutic agent” includes a “drug” or a “vaccine.” This term include externally and internally administered topical, localized and systemic human and animal pharmaceuticals, treatments, remedies, nutraceuticals, cosmeceuticals, biologicals, devices, diagnostics and contraceptives, including preparations useful in clinical and veterinary screening, prevention, prophylaxis, healing, wellness, detection, imaging, diagnosis, therapy, surgery, monitoring, cosmetics, prosthetics, forensics and the like. This term can also be used in reference to agriceutical, workplace, military, industrial and environmental therapeutics or remedies comprising selected molecules or selected nucleic acid sequences capable of recognizing cellular receptors, membrane receptors, hormone receptors, therapeutic receptors, microbes, viruses or selected targets comprising or capable of contacting plants, animals and/or humans. This term can also specifically include nucleic acids and compounds comprising nucleic acids that produce a therapeutic effect, for example deoxyribonucleic acid (DNA), ribonucleic acid (RNA), nucleic acid analogues (e.g., locked nucleic acid (LNA), peptide nucleic acid (PNA), xeno nucleic acid (XNA)), or mixtures or combinations thereof, including, for example, DNA nanoplexes, siRNA, microRNA, shRNA, aptamers, ribozymes, decoy nucleic acids, antisense nucleic acids, RNA activators, and the like. Generally, any therapeutic agent can be included in the composition provided herein.

The term “therapeutic agent” also includes an agent that is capable of providing a local or systemic biological, physiological, or therapeutic effect in the biological system to which it is applied. For example, the therapeutic agent can act to control infection or inflammation, enhance cell growth and tissue regeneration, control tumor growth, act as an analgesic, promote anti-cell attachment, and enhance bone growth, among other functions. Other suitable therapeutic agents can include anti-viral agents, hormones, antibodies, or therapeutic proteins. Other therapeutic agents include prodrugs, which are agents that are not biologically active when administered but, upon administration to a subject are converted to biologically active agents through metabolism or some other mechanism. Additionally, a silk-based drug delivery composition can contain one therapeutic agent or combinations of two or more therapeutic agents.

A therapeutic agent can include a wide variety of different compounds, including chemical compounds and mixtures of chemical compounds, e.g., small organic or inorganic molecules; saccharines; oligosaccharides; polysaccharides; biological macromolecules, e.g., peptides, proteins, and peptide analogs and derivatives; peptidomimetics; antibodies and antigen binding fragments thereof; nucleic acids; nucleic acid analogs and derivatives; an extract made from biological materials such as bacteria, plants, fungi, or animal cells; animal tissues; naturally occurring or synthetic compositions; and any combinations thereof. In some aspects, the therapeutic agent is a small molecule.

The term “bioactivity,” as used herein in reference to an active agent, generally refers to the ability of an active agent to interact with a biological target and/or to produce an effect on a biological target. For example, bioactivity can include, without limitation, elicitation of a stimulatory, inhibitory, regulatory, toxic or lethal response in a biological target. The biological target can be a molecule or a cell. For example, a bioactivity can refer to the ability of an active agent to modulate the effect/activity of an enzyme, block a receptor, stimulate a receptor, modulate the expression level of one or more genes, modulate cell proliferation, modulate cell division, modulate cell morphology, or any combination thereof. In some instances, a bioactivity can refer to the ability of a compound to produce a toxic effect in a cell. Exemplary cellular responses include, but are not limited to, lysis, apoptosis, growth inhibition, and growth promotion; production, secretion, and surface expression of a protein or other molecule of interest by the cell; membrane surface molecule activation including receptor activation; transmembrane ion transports; transcriptional regulations; changes in viability of the cell; changes in cell morphology; changes in presence or expression of an intracellular component of the cell; changes in gene expression or transcripts; changes in the activity of an enzyme produced within the cell; and changes in the presence or expression of a ligand and/or receptor (e.g., protein expression and/or binding activity). Methods for assaying different cellular responses are well known to one of skill in the art, e.g., western blot for determining changes in presence or expression of an endogenous protein of the cell, or microscopy for monitoring the cell morphology in response to the active agent, or FISH and/or qPCR for the detection and quantification of changes in nucleic acids. Bioactivity can be determined in some embodiments, for example, by assaying a cellular response.

In reference to an antibody, the term “bioactivity” includes, but is not limited to, epitope or antigen binding affinity, the in vivo and/or in vitro stability of the antibody, the immunogenic properties of the antibody, e.g., when administered to a human subject, and/or the ability to neutralize or antagonize the bioactivity of a target molecule in vivo or in vitro. The aforementioned properties or characteristics can be observed or measured using art-recognized techniques including, but not limited to, scintillation proximity assays, ELISA, ORIGEN immunoassay (IGEN), fluorescence quenching, fluorescence ELISA, competitive ELISA, SPR analysis including, but not limited to, SPR analysis using a BIAcore biosenser, in vitro and in vivo neutralization assays (see, for example, International Publication No. WO 2006/062685), receptor binding, and immunohistochemistry with tissue sections from different sources including human, primate, or any other source as needed. In reference to an immunogen, the “bioactivity” includes immunogenicity, the definition of which is discussed in detail later. In reference to a virus, the “bioactivity” includes infectivity, the definition of which is discussed in detail later. In reference to a contrast agent, e.g., a dye, the “bioactivity” refers to the ability of a contrast agent when administered to a subject to enhance the contrast of structures or fluids within the subject's body. The bioactivity of a contrast agent also includes, but is not limited to, its ability to interact with a biological environment and/or influence the response of another molecule under certain conditions.

As used herein, the term “small molecule” can refer to compounds that are “natural product-like,” however, the term “small molecule” is not limited to “natural product-like” compounds. Rather, a small molecule is typically characterized in that it contains several carbon-carbon bonds, and has a molecular weight of less than 5000 Daltons (5 kDa), preferably less than 3 kDa, still more preferably less than 2 kDa, and most preferably less than 1 kDa. In some cases it is preferred that a small molecule have a molecular weight equal to or less than 700 Daltons.

Exemplary therapeutic agents include, but are not limited to, those found in Harrison's Principles of Internal Medicine, 13th Edition, Eds. T. R. Harrison et al. McGraw-Hill N.Y., NY; Physicians' Desk Reference, 50th Edition, 1997, Oradell New Jersey, Medical Economics Co.; Pharmacological Basis of Therapeutics, 8th Edition, Goodman and Gilman, 1990; United States Pharmacopeia, The National Formulary, ETSP XII NF XVII, 1990, the complete contents of all of which are incorporated herein by reference.

Therapeutic agents include the herein disclosed categories and specific examples. It is not intended that the category be limited by the specific examples. Those of ordinary skill in the art will recognize also numerous other compounds that fall within the categories and that are useful according to the present disclosure. Examples include a radiosensitizer, a steroid, a xanthine, a beta-2-agonist bronchodilator, an anti-inflammatory agent, an analgesic agent, a calcium antagonist, an angiotensin-converting enzyme inhibitors, a beta-blocker, a centrally active alpha-agonist, an alpha-1-antagonist, an anticholinergic/antispasmodic agent, a vasopressin analogue, an anti arrhythmic agent, an antiparkinsonian agent, an antiangina/antihypertensive agent, an anticoagulant agent, an antiplatelet agent, a sedative, an ansiolytic agent, a peptidic agent, a biopolymeric agent, an antineoplastic agent, a laxative, an antidiarrheal agent, an antimicrobial agent, an antifungal agent, a vaccine, a protein, or a nucleic acid. In a further aspect, the pharmaceutically active agent can be coumarin, albumin, steroids such as betamethasone, dexamethasone, methylprednisolone, prednisolone, prednisone, triamcinolone, budesonide, hydrocortisone, and pharmaceutically acceptable hydrocortisone derivatives; xanthines such as theophylline and doxophylline; beta-2-agonist bronchodilators such as salbutamol, fenterol, clenbuterol, bambuterol, salmeterol, fenoterol; antiinflammatory agents, including antiasthmatic anti-inflammatory agents, antiarthritis antiinflammatory agents, and non-steroidal antiinflammatory agents, examples of which include but are not limited to sulfides, mesalamine, budesonide, salazopyrin, diclofenac, pharmaceutically acceptable diclofenac salts, nimesulide, naproxene, acetaminophen, ibuprofen, ketoprofen and piroxicam; analgesic agents such as salicylates; calcium channel blockers such as nifedipine, amlodipine, and nicardipine; angiotensin converting enzyme inhibitors such as captopril, benazepril hydrochloride, fosinopril sodium, trandolapril, ramipril, lisinopril, enalapril, quinapril hydrochloride, and moexipril hydrochloride; beta-blockers (i.e., beta adrenergic blocking agents) such as sotalol hydrochloride, timolol maleate, esmolol hydrochloride, carteolol, propanolol hydrochloride, betaxolol hydrochloride, penbutolol sulfate, metoprolol tartrate, metoprolol succinate, acebutolol hydrochloride, atenolol, pindolol, and bisoprolol fumarate; centrally active alpha-2-agonists such as clonidine; alpha-1-antagonists such as doxazosin and prazosin; anticholinergic/antispasmodic agents such as dicyclomine hydrochloride, scopolamine hydrobromide, glycopyrrolate, clidinium bromide, flavoxate, and oxybutynin; vasopressin analogues such as vasopressin and desmopressin; antiarrhythmic agents such as quinidine, lidocaine, tocainide hydrochloride, mexiletine hydrochloride, digoxin, verapamil hydrochloride, propafenone hydrochloride, flecainide acetate, procainamide hydrochloride, moricizine hydrochloride, and disopyramide phosphate; antiparkinsonian agents, such as dopamine, L-Dopa/Carbidopa, selegiline, dihydroergocryptine, pergolide, lisuride, apomorphine, and bromocryptine; antiangina agents and antihypertensive agents such as isosorbide mononitrate, isosorbide dinitrate, propranolol, atenolol and verapamil; anticoagulant and antiplatelet agents such as Coumadin, warfarin, acetylsalicylic acid, and ticlopidine; sedatives such as benzodiazapines and barbiturates; ansiolytic agents such as lorazepam, bromazepam, and diazepam; peptidic and biopolymeric agents such as calcitonin, leuprolide and other LTRH agonists, hirudin, cyclosporin, insulin, somatostatin, protirelin, interferon, desmopressin, somatotropin, thymopentin, pidotimod, erythropoietin, interleukins, melatonin, granulocyte/macrophage-CSF, and heparin; antineoplastic agents such as etoposide, etoposide phosphate, cyclophosphamide, methotrexate, 5-fluorouracil, vincristine, doxorubicin, cisplatin, hydroxyurea, leucovorin calcium, tamoxifen, flutamide, asparaginase, altretamine, mitotane, and procarbazine hydrochloride; laxatives such as senna concentrate, casanthranol, bisacodyl, and sodium picosulphate; antidiarrheal agents such as difenoxine hydrochloride, loperamide hydrochloride, furazolidone, diphenoxylate hdyrochloride, and microorganisms; vaccines such as bacterial and viral vaccines; antimicrobial agents such as penicillins, cephalosporins, and macrolides, antifungal agents such as imidazolic and triazolic derivatives; and nucleic acids such as DNA sequences encoding for biological proteins, and antisense oligonucleotides.

Anti-cancer agents include alkylating agents, platinum agents, antimetabolites, topoisomerase inhibitors, antitumor antibiotics, antimitotic agents, aromatase inhibitors, thymidylate synthase inhibitors, DNA antagonists, farnesyltransferase inhibitors, pump inhibitors, histone acetyltransferase inhibitors, metalloproteinase inhibitors, ribonucleoside reductase inhibitors, TNF alpha agonists/antagonists, endothelinA receptor antagonists, retinoic acid receptor agonists, immuno-modulators, hormonal and antihormonal agents, photodynamic agents, and tyrosine kinase inhibitors.

Antibiotics include aminoglycosides (e.g., gentamicin, tobramycin, netilmicin, streptomycin, amikacin, neomycin), bacitracin, corbapenems (e.g., imipenem/cislastatin), cephalosporins, colistin, methenamine, monobactams (e.g., aztreonam), penicillins (e.g., penicillin G, penicillinV, methicillin, natcillin, oxacillin, cloxacillin, dicloxacillin, ampicillin, amoxicillin, carbenicillin, ticarcillin, piperacillin, mezlocillin, azlocillin), polymyxin B, quinolones, and vancomycin; and bacteriostatic agents such as chloramphenicol, clindanyan, macrolides (e.g., erythromycin, azithromycin, clarithromycin), lincomyan, nitrofurantoin, sulfonamides, tetracyclines (e.g., tetracycline, doxycycline, minocycline, demeclocyline), and trimethoprim. Also included are metronidazole, fluoroquinolones, and ritampin.

Enzyme inhibitors are substances which inhibit an enzymatic reaction. Examples of enzyme inhibitors include edrophonium chloride, N-methylphysostigmine, neostigmine bromide, physostigmine sulfate, tacrine, tacrine, 1-hydroxy maleate, iodotubercidin, p-bromotetramiisole, 10-(alpha-diethylaminopropionyl)-phenothiazine hydrochloride, calmidazolium chloride, hemicholinium-3,3,5-dinitrocatechol, diacylglycerol kinase inhibitor I, diacylglycerol kinase inhibitor II, 3-phenylpropargylamine, N°-monomethyl-Larginine acetate, carbidopa, 3-hydroxybenzylhydrazine, hydralazine, clorgyline, deprenyl, hydroxylamine, iproniazid phosphate, 6-MeO-tetrahydro-9H-pyrido-indole, nialamide, pargyline, quinacrine, semi carb azide, tranylcypromine, N,N-diethylaminoethyl-2,2-diphenylvalerate hydrochloride, 3-isobutyl-1-methylxanthne, papaverine, indomethacind, 2-cyclooctyl-2-hydroxy ethylamine hydrochloride, 2,3-dichloro-a-methylbenzylamine (DCMB), 8,9-dichloro-2,3,4,5-tetrahydro-1H-2-benzazepine hydrochloride, p-amino glutethimide, p-aminoglutethimide tartrate, 3-iodotyrosine, alpha-methyltyrosine, acetazolamide, dichlorphenamide, 6-hydroxy-2-benzothiazolesulfonamide, and allopurinol.

Antihistamines include pyrilamine, chlorpheniramine, and tetrahydrazoline, among others.

Anti-inflammatory agents include corticosteroids, nonsteroidal anti-inflammatory drugs (e.g., aspirin, phenylbutazone, indomethacin, sulindac, tolmetin, ibuprofen, piroxicam, and fenamates), acetaminophen, phenacetin, gold salts, chloroquine, D-Penicillamine, methotrexate colchicine, allopurinol, probenecid, and sulfinpyrazone.

Muscle relaxants include mephenesin, methocarbomal, cyclobenzaprine hydrochloride, trihexylphenidyl hydrochloride, levodopa/carbidopa, and biperiden.

Anti-spasmodics include atropine, scopolamine, oxyphenonium, and papaverine.

Analgesics include aspirin, phenybutazone, idomethacin, sulindac, tolmetic, ibuprofen, piroxicam, fenamates, acetaminophen, phenacetin, morphine sulfate, codeine sulfate, meperidine, nalorphine, opioids (e.g., codeine sulfate, fentanyl citrate, hydrocodone bitartrate, loperamide, morphine sulfate, noscapine, norcodeine, normorphine, thebaine, nor-binaltorphimine, buprenorphine, chlomaltrexamine, funaltrexamione, nalbuphine, nalorphine, naloxone, naloxonazine, naltrexone, and naltrindole), procaine, lidocain, tetracaine and dibucaine. Ophthalmic agents include sodium fluorescein, rose bengal, methacholine, adrenaline, cocaine, atropine, alpha-chymotrypsin, hyaluronidase, betaxalol, pilocarpine, timolol, timolol salts, and combinations thereof.

Prostaglandins are art recognized and are a class of naturally occurring chemically related long-chain hydroxy fatty acids that have a variety of biological effects.

Anti-depressants are substances capable of preventing or relieving depression.

Examples of anti-depressants include imipramine, amitriptyline, nortriptyline, protriptyline, desipramine, amoxapine, doxepin, maprotiline, tranylcypromine, phenelzine, and isocarboxazide.

Trophic factors are factors whose continued presence improves the viability or longevity of a cell trophic factors include, without limitation, platelet-derived growth factor (PDGP), neutrophil-activating protein, monocyte chemoattractant protein, macrophage-inflammatory protein, platelet factor, platelet basic protein, and melanoma growth stimulating activity; epidermal growth factor, transforming growth factor (alpha), fibroblast growth factor, platelet-derived endothelial cell growth factor, insulin-like growth factor, glial derived growth neurotrophic factor, ciliary neurotrophic factor, nerve growth factor, bone growth/cartilage-inducing factor (alpha and beta), bone morphogenetic proteins, interleukins (e.g., interleukin inhibitors or interleukin receptors, including interleukin 1 through interleukin 10), interferons (e.g., interferon alpha, beta and gamma), hematopoietic factors, including erythropoietin, granulocyte colony stimulating factor, macrophage colony stimulating factor and granulocyte-macrophage colony stimulating factor; tumor necrosis factors, and transforming growth factors (beta), including beta-1, beta-2, beta-3, inhibin, and activin.

Hormones include estrogens (e.g., estradiol, estrone, estriol, diethylstibestrol, quinestrol, chlorotrianisene, ethinyl estradiol, mestranol), anti-estrogens (e.g., clomiphene, tamoxifen), progestins (e.g., medroxyprogesterone, norethindrone, hydroxyprogesterone, norgestrel), antiprogestin (mifepristone), androgens (e.g, testosterone cypionate, fluoxymesterone, danazol, testolactone), anti-androgens (e.g., cyproterone acetate, flutamide), thyroid hormones (e.g., triiodothyronne, thyroxine, propylthiouracil, methimazole, and iodixode), and pituitary hormones (e.g., corticotropin, sumutotropin, oxytocin, and vasopressin). Hormones are commonly employed in hormone replacement therapy and/or for purposes of birth control. Steroid hormones, such as prednisone, are also used as immunosuppressants and anti-inflammatories. In some aspects, the additive is an agent that stimulates tissue formation, and/or healing and regrowth of natural tissues, and any combinations thereof. Agents that increase formation of new tissues and/or stimulates healing or regrowth of native tissue at the site of injection can include, but are not limited to, fibroblast growth factor (FGF), transforming growth factor-beta (TGF-beta, platelet-derived growth factor (PDGF), epidermal growth factors (EGFs), connective tissue activated peptides (CTAPs), osteogenic factors including bone morphogenic proteins, heparin, angiotensin II (A-II) and fragments thereof, insulin-like growth factors, tumor necrosis factors, interleukins, colony stimulating factors, erythropoietin, nerve growth factors, interferons, biologically active analogs, fragments, and derivatives of such growth factors, and any combinations thereof.

In some aspects, the silk composition can further comprise at least one additional material for soft tissue augmentation, e.g., dermal filler materials, including, but not limited to, poly(methyl methacrylate) microspheres, hydroxylapatite, poly(L-lactic acid), collagen, elastin, and glycosaminoglycans, hyaluronic acid, commercial dermal filler products such as BOTOX® (from Allergan), DYSPORT®, COSMODERM®, EVOLENCE®, RADIESSE®, RESTYLANE®, JUVEDERM® (from Allergan), SCULPTRA®, PERLANE®, and CAPTIQEIE®, and any combinations thereof.

In some aspects, the additive is a wound healing agent. As used herein, a “wound healing agent” is a compound or composition that actively promotes wound healing process.

Exemplary wound healing agents include, but are not limited to dexpanthenol; growth factors; enzymes, hormones; povidon-iodide; fatty acids; anti-inflammatory agents; antibiotics; antimicrobials; antiseptics; cytokines; thrombin; angalgesics; opioids; aminoxyls; furoxans; nitrosothiols; nitrates and anthocyanins; nucleosides, such as adenosine; and nucleotides, such as adenosine diphosphate (ADP) and adenosine triphosphate (ATP); neutotransmitter/neuromodulators, such as acetylcholine and 5-hydroxytryptamine (serotonin/5-HT); histamine and catecholamines, such as adrenalin and noradrenalin; lipid molecules, such as 5 sphingosine-1-phosphate and lysophosphatidic acid; amino acids, such as arginine and lysine; peptides such as the bradykinins, substance P and calcium gene-related peptide (CGRP); nitric oxide; and any combinations thereof.

In certain aspects, the active agents provided herein are immunogens. In one aspect, the immunogen is a vaccine. Most vaccines are sensitive to environmental conditions under which they are stored and/or transported. For example, freezing may increase reactogenicity (e.g., capability of causing an immunological reaction) and/or loss of potency for some vaccines (e.g., HepB, and DTaP/IPV/FQB), or cause hairline cracks in the container, leading to contamination. Further, some vaccines (e.g., BCG, Varicella, and MMR) are sensitive to heat. Many vaccines (e.g., BCG, MMR, Varicella, Meningococcal C Conjugate, and most DTaP-containing vaccines) are light sensitive. See, e.g., Galazka et ak, Thermostability of vaccines, in Global Programme for Vaccines & Immunization (World Health Organization, Geneva, 1998); Peetermans et ak, Stability of freeze-dried rubella virus vaccine (Cendehill strain) at various temperatures, 1 J. Biological Standardization 179 (1973). Thus, the compositions and methods provided herein also provide for stabilization of vaccines regardless of the cold chain and/or other environmental conditions.

In some aspects, the additive is a cell, e.g., a biological cell. Cells useful for incorporation into the composition can come from any source, e.g., mammalian, insect, plant, etc. In some aspects, the cell can be a human, rat or mouse cell. In general, cells to be used with the compositions provided herein can be any types of cells. In general, the cells should be viable when encapsulated within compositions. In some aspects, cells that can be used with the composition include, but are not limited to, mammalian cells (e.g. human cells, primate cells, mammalian cells, rodent cells, etc.), avian cells, fish cells, insect cells, plant cells, fungal cells, bacterial cells, and hybrid cells. In some aspects, exemplary cells that can be can be used with the compositions include platelets, activated platelets, stem cells, totipotent cells, pluripotent cells, and/or embryonic stem cells. In some aspects, exemplary cells that can be encapsulated within compositions include, but are not limited to, primary cells and/or cell lines from any tissue. For example, cardiomyocytes, myocytes, hepatocytes, keratinocytes, melanocytes, neurons, astrocytes, embryonic stem cells, adult stem cells, hematopoietic stem cells, hematopoietic cells (e.g. monocytes, neutrophils, macrophages, etc.), ameloblasts, fibroblasts, chondrocytes, osteoblasts, osteoclasts, neurons, sperm cells, egg cells, liver cells, epithelial cells from lung, epithelial cells from gut, epithelial cells from intestine, liver, epithelial cells from skin, etc, and/or hybrids thereof, can be included in the silk/platelet compositions disclosed herein. Those skilled in the art will recognize that the cells listed herein represent an exemplary, not comprehensive, list of cells. Cells can be obtained from donors (allogenic) or from recipients (autologous). Cells can be obtained, as a non-limiting example, by biopsy or other surgical means known to those skilled in the art.

In some aspects, the cell can be a genetically modified cell. A cell can be genetically modified to express and secrete a desired compound, e.g. a bioactive agent, a growth factor, differentiation factor, cytokines, and the like. Methods of genetically modifying cells for expressing and secreting compounds of interest are known in the art and easily adaptable by one of skill in the art.

Differentiated cells that have been reprogrammed into stem cells can also be used.

For example, human skin cells reprogrammed into embryonic stem cells by the transduction of Oct3/4, Sox2, c-Myc and Klf4 (Junying Yu, et. ah, Science, 2007, 318, 1917-1920 and Takahashi K. et. ah, Cell, 2007, 131, 1-12).

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion of additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected. For example, any of the features or functions of any of the embodiments disclosed herein may be incorporated into any of the other embodiments disclosed herein.

### EXAMPLES

### Example 1

Silk, a dielectric particle, can be used as a toner for white color or as a carrier for compounds that provide functionality such as color, etc. Disclosed herein are silk powders that have been functionalized and loaded into toner cartridges to be used in a laser printing platform to print sensors by the sheet. Silk powder is a stable form for storing as a raw material. Eliminating the liquid format of silk enables a reinterpretation of the design and process to make sensors and functional devices.

By virtue of silk being a carrier, a suite of functional toners are enabled. Certain categories of inks include thermochromic inks, thermo-reactive inks, biologically active, scented, edible, and color. This enables a wide array of potential uses. One example includes functional printing for medical applications to make assays using biofunctional inks (proteins, fluorophores, conductive inks, thermoreactive inks), functionalized microfluidics (prepared sheets and then put them in a in a wax printer). Disclosed herein is an adhoc laser printer that is sterile (i.e., is medical grade) and has sterile printing cartridges. This might be a small laser printer with miniaturized toner that then can be used to print assays for disease detection using particular reagents.

Another example includes patterned printing of artwork or even sensors using patterns, origami folds, photochromic or thermochromics inks, vanishing codes that can be reconstructed upon reaction with the suitable developer ink.

Another example includes sustainable printing. Toner waste is a big byproduct of paper recycling and often ends up in waste sludge. Using a biodegradable material such as silk for toner could significantly reduce this problem. Moreover, silk-based colored inks could be obtained from silk textile waste streams. Silk toner by itself will be a very good white color because of light scattering by the material. Colored toners can be achieved by using a sequence of additives (e.g., anthocyanine and red beet red toner ink). Greys could be obtained through the use of squid ink attached to silk. Black will be the most complex one to obtain, and an exampled approach to obtain is to use a post-process to carbonize the silk and turn the white to black. This also enables light browns during partial charring of the silk protein. This might need a local temperature of 400 degrees. Potentially, powders from crushed optical films that retained optical properties could be used to offer iridescent or opalescent colors.

### Advantages of Biotoners:

An advantage of biotoners is the dielectric attraction that the toner particles have to adhere. Silk is a very negatively charged molecule and its end material as seen in its fine formats ends up being really sticky and dielectric, which this is typical of a lot of structural proteins including cellulose. Cellulose powder with the right polarity could probably be accelerated under the voltages used in a laser printer in such a way that it sticks together. The dielectric nature of the material and this net charge in the powder is conducive to its use as a toner.

Another advantage is the setting or curing properties of the toner material to bond with the underlying substrate. One would think that if the printed silk particles aren't set or cured using vapor (moisture) the bond with the underlying substrate may be weak. However, in this case, the laserprinted silk is solidly and firmly attached to the substrate. Without wishing to be bound by any particular theory, it appears that with silk, the setting process is through cross-linking precluding the post-processing step. Modulating the crosslinking will facilitate tunable binding of the ink to the substrate thus offering both permanent and nonpermanent binding to the substrate. The latter could be useful for a range of fields including aesthetic patterns and others.

In examples, the structure size and the crystallinity of silk toners can be matched to the particle size of existing toners. Depending on the size range, suitable processes such as spray drying, lyophilization and so on may be specified.

### Example 2

Laser printing is a staple of commercial and industrial printing. Disclosed herein is a new kind of printing which the inventors have named dry bioprinting. Dry bioprinting can reach more markets and will make it easier to recycle materials in the printing industry. Recycled materials, from inside and outside the industry, can be added to new production processes without added complexity. This helps create a more circular economy where resources are reused efficiently. The disclosure herein details how the incorporation of silk fibroin as a toner material could open new avenues of production, reduce logistical overhead for existing manufacturing, and negate the environmental impact of laser printing by using biofriendly materials in a highly circularizable economy.

Laser printing falls into the umbrella category of xerography, or dry printing methods. Xerography is performed by applying a uniform static electrical charge to a plate or roller made of materials like selenium or organic photoconductor (OPC), which becomes electrically conductive under illumination. A pattern of light is applied to the charged plate or roller with either a projected image or a scanned laser or LED array. This light causes certain regions to become conductive and dissipate their static charge while others remain charged, thus creating a latent image. A fine powder of dry particles is applied to the plate or roller, which adheres to the charged regions via electrostatic attraction. This roller or plate is then pressed up against the substrate to be printed on and an electrostatic charge is applied uniformly to or behind the substrate to enable transfer of the material. Any residual material left on the roller or plate is collected for recycling, then the plate is uniformly discharged by flood illumination and the process is ready to begin again.

Xerographic printing, more commonly called laser printing, is nearly ubiquitous in commercial use but also finds industrial uses as well. These printers are the go-to printing method for on-demand printing of text documents in commercial, academic, and government spaces due to the quality and durability of prints they produce as well as the improved cost-efficiency they offer over ink-jet style printers. Industrially they are used to produce items such as labels, barcodes, and graphics, and are the method of choice when a label must be resilient to wet conditions.

While laser printing solves many commercial issues, it has created some issues of its own. Firstly, the primary component of laser printer toner is a petrochemical plastic (typically polystyrene-butadiene copolymer) that is used to house the chromic components (often carbon black or ferric oxide for black pigments, organic pigments for the colored toner), all of which are made from petrochemical feedstocks. While laser toner is theoretically recyclable, the cost and complexity of recycling makes it challenging and, therefore, toner is produced almost exclusively from virgin stocks. The waste toner is also a contributor to environmental microplastics, nanoparticles and airborne particulate matter in office spaces.

Secondly, the market for on-demand printing, including those that use toner, is declining as digital methods for distributing and storing documents become more common. Although new opportunities are emerging, traditional polymer-based toners aren't suitable for these applications. For instance, there is interest in printing on biodegradable or edible packaging, but the current toners made from petrochemicals aren't fit for this purpose.

Another area of growth is in printing materials such as sensors or devices that manage fluid flow. These products would benefit from a coating that is both non-reactive and capable of retaining moisture to ensure proper functionality after printing.

### Silk Xerography

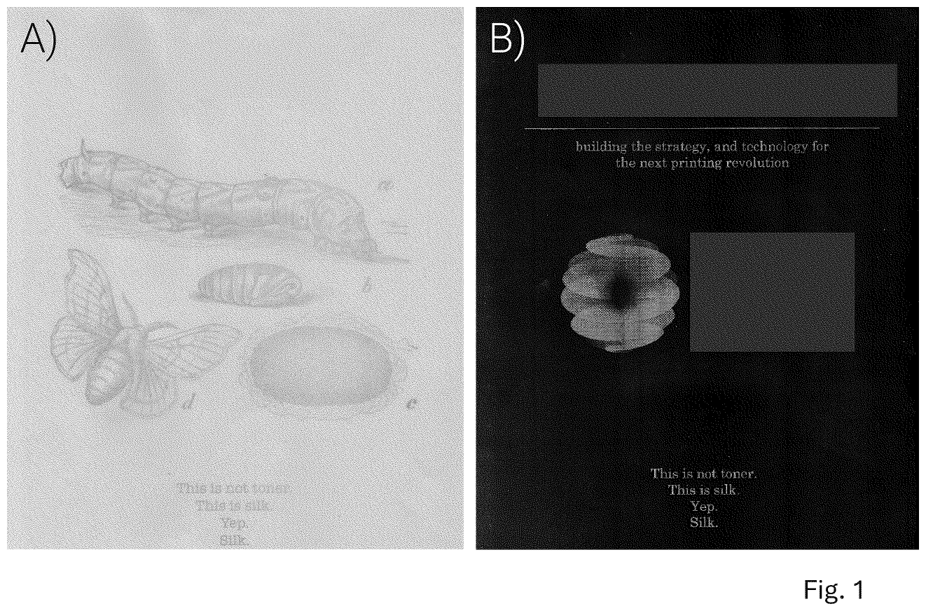

Replacing the polymeric component of toner with silk fibroin can transform the laser printing process from one that creates health and environmental hazards to one that enables health and reduces the environmental impact of other sectors of the economy. Silk fibroin microparticles are readily created by a variety of processes including spray drying, ball milling and electrospraying. These particles are transferrable by the electrostatic charges on the OPC roller with no additional modification and can form patterns on a variety of substrates (FIG. 1). These particles can then be set by reflowing with water aerosol, after which they form highly transparent films. These films can be made water-insoluble by exposure to heated water vapor or can be left in a dissolvable state for transient applications.

Disclosed herein are silk fibroin inks as a 1-for-1 replacement for traditional toners. For black inks, composites of fibroin and natural chromophores such as melanin, fulvic acid, and activated charcoal are edible, ecofriendly alternatives. These compounds can provide a deep black color and are already FDA approved for use in foods, seen in products like BLK. For colored toners, silk is replete with tyrosine functional groups and is thus an excellent substrate for azo-dyes. These dyes directly bind to the fibroin polymer and are thus immune from leaching and washing out, increasing the durability of the final prints. Together, these could be used to laser-print on edible or biodegradable items. Next generation green packaging is composed of biopolymers like proteins, polysaccharides, chitin, and others that are fully biodegradable. These could not be printed upon with petrochemical toners, as they would introduce non-degradable microplastics into the system. Fibroin toners on the other hand are fully degradable in both at-home and industrial composting systems and have no microplastic components. Beyond that, some fully edible packaging exists, such as rice-paper, which would require food-safe toners to print on. Fibroin is already used as an edible food-additive and fibroin toners would be well-suited for printing on edible packaging or directly onto food items.

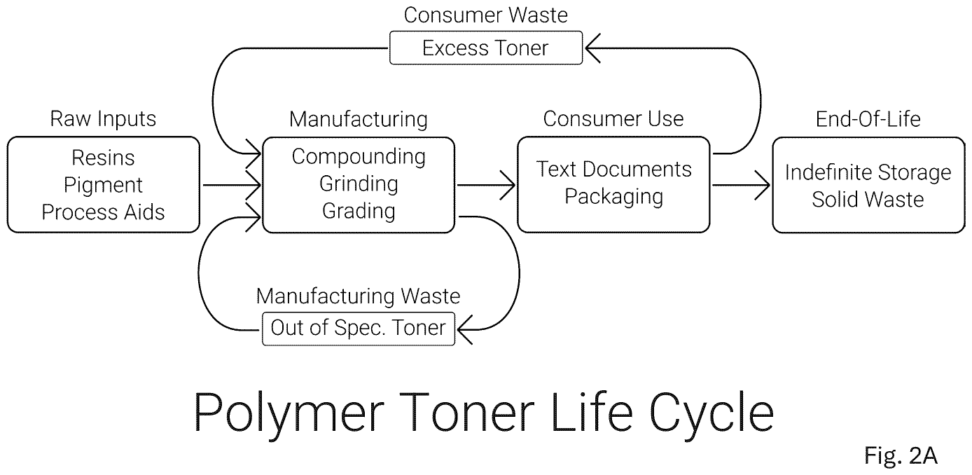

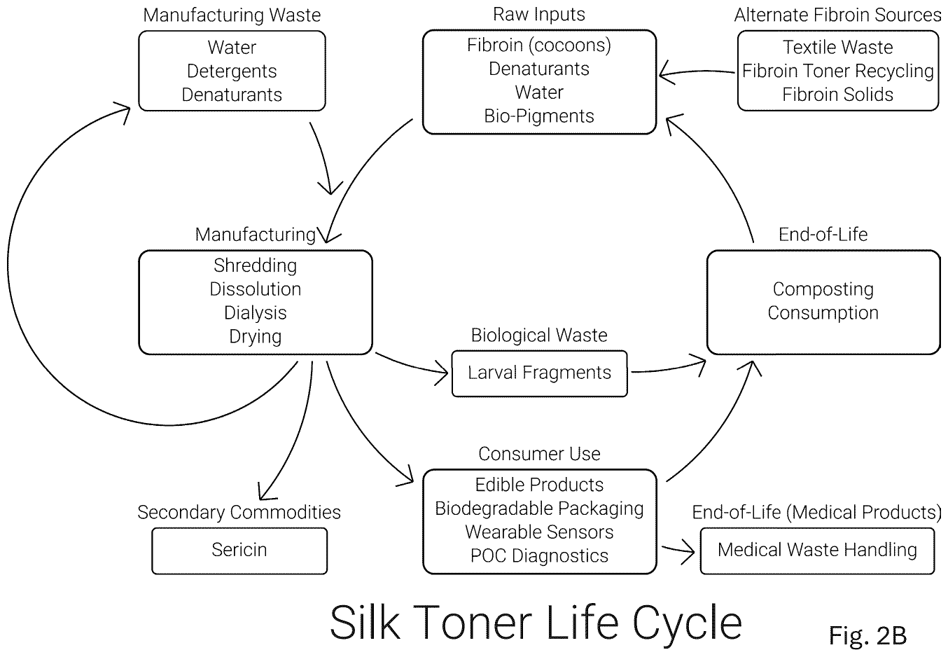

While fibroin is a completely renewable resource, it can also be economically advantageous to be able to draw from recycled feedstocks in addition to virgin sources. Fibroin has a large (and untapped) supply of recyclable fibers from the textile industry, which produces over 11 million tons of silk waste per year. During growth, cocoons are often discarded for physical damage from either rough handling or the hatching of the moth. During fabric weaving, large sections are trimmed from rolls and weaves and discarded. During the manufacture of textiles, large off-cuts are discarded if they cannot be incorporated into the clothing pattern. Finally after being used damaged or worn-out silk garments are often discarded. All these sources represent potential feedstocks for toner creation. Those early in production can be directly intermixed with virgin stocks for the regeneration process. Those later in production can be used differently. Fibroin regenerated from discarded silk garments often retains the dye components from the original clothing and can be made directly into colored toners. Referring to FIG. 2, life cycles of conventional polymer toner (FIG. 2A) and silk toner (FIG. 2B) are shown for comparison.

Silk toners could also reduce the overhead of producing point-of-care diagnostic devices, such as pregnancy tests, Covid tests and similar consumable testing devices. Firstly, the dry format of xerographic printing provides numerous benefits, as biomolecules are substantially more stable in the dry state and thus are often shipped and stored as lyophilized powder. Xerographic printing maintains that dry state throughout the printing process, thus eliminating solubilization, liquid handling, and drying from the manufacturing scheme. Secondly, fibroin acts to actively stabilize labile biomolecules and enables the elimination of refrigeration and cold chains in reagent storage and shipping. The final device will also benefit from this stability as the labile components are continuously encapsulated in fibroin throughout the entire life cycle of the product.

Silk fibroin has also been proven to facilitate advanced optical and chemical functionalities. Due to the high visible light transparency of silk fibroin, it can also incorporate optically active additives like gold nanoparticles to exploit their plasmonic resonance. Silk can also house photochemical additives such as tetrazole-ene photoclick pairs, facilitating the printing of photoreactive and fluorescent materials.

Finally, in much the same way that silk stabilizes enzymes, it can also stabilize antibiotics like Rifampicin, enabling the creation of antibiotic-resistance test strips that can be stored at room temperature.

### How Silk Xerography Works

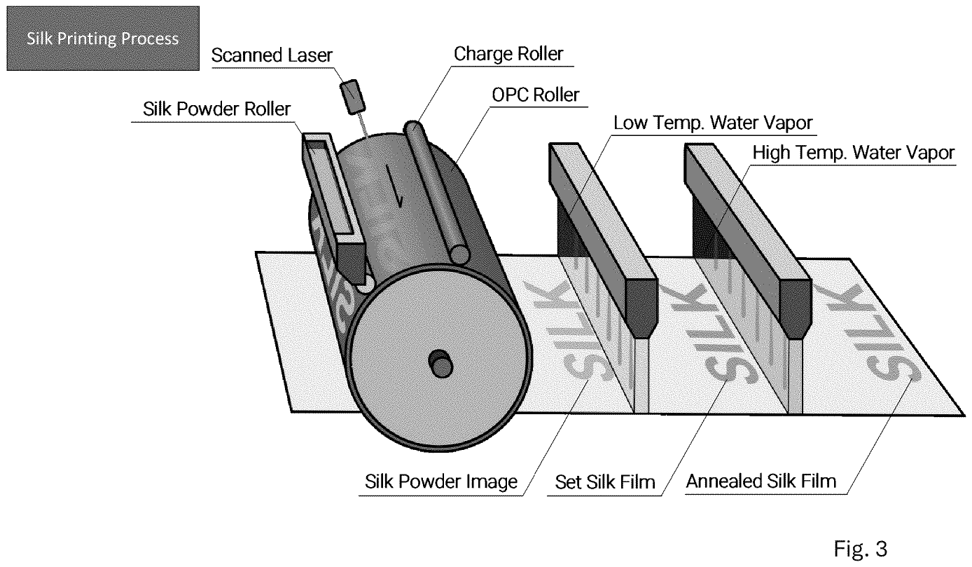

Silk xerographic printing resembles xerography with polymer toners. The light-reactive roller or plate is charged, the charge photographical patterned, and the powder is applied in a similar manner (FIG. 3). This means that existing technology can be applied without modification. Silk toner is different in how it is set compared to ordinary toner, as it displays little in the way of thermoplastic properties. Instead, the reflow of the toner is accomplished by water vapor that partially dissolves the toner, achieving setting by either wetting out on smooth surfaces, like cellulose acetate films, or infiltrating porous surfaces, like paper or cloth. Once set, the fibroin remains water soluble, but that can be altered by tuning the secondary structure of the silk protein.

Silk fibroin has two primary solid states, amorphous and crystalline, characterized by the secondary structural organization of the protein. In the amorphous state, the protein has no consistent secondary structure and exists largely as random coils. In the crystalline state, the protein adopts a regular crystalline structure that substantially alters the physical and mechanical properties of the bulk material. In the amorphous state, the silk has a lower melting point, modulus, and is, crucially, still water soluble. This final trait enables the prints to be set by using water vapor to reflow the silk and cause it to bind to the printing substrate. However, once set, the final use of the item will determine the ideal secondary structure to use.

The annealing process with silk fibroin adds secondary flexibility to prints and larger constructs made with this method. Prints may be left intentionally unannealed for transient or edible applications, where remaining water-soluble is a desirable feature. In cases where the print must be permanent, annealing is readily achievable with exposure to high humidity. Water insolubility can be achieved in as little as 5 minutes at 45 degrees Celsius and 90% relative humidity. This can be further accelerated by using higher temperatures, with the limit being high-pressure steam annealing, which can achieve j-sheet structures in seconds. Alternatively, if the silk is loaded with a thermolabile compound, lower temperatures can be used to more gently anneal the print at the cost of longer residence times.

### Production of Toner

Production of silk toner can be performed with standard industrial powder fabrication and handling techniques. Spray drying is a well-established method for creating fine, free-flowing powders with particulate on the micron scale. Here, aqueous fibroin solution is aerosolized into a stream of hot air that quickly disperses the liquid into fine droplets and removes the water in a single step, resulting in a fine powder. Control of this technique has been well characterized in the literature and the control parameters to alter for creating particles of different sizes and morphologies is well understood (See Lintingre, E., Lequeux, F., Talini, L. & Tsapis, N. Control of particle morphology in the spray drying of colloidal suspensions. Soft Matter 12, 7435-7444 (2016), which is incorporated herein in its entirety by reference for all purposes). This technique can produce toner in bulk, but the temperatures involved may be too high for certain thermally sensitive components.

An alternate technique for creating silk toners is fluidized bed grinding. In this method, large fibroin granules would be loaded into a container that forces air through the mixture to cause constant collisions between the particles and results in mutual abrasive action that reduces the size of the granules over time. This technique is already commonplace in the fabrication of toners, so existing infrastructure can be used with minimal modification to workflow.

A final option for small batch processes or highly sensitive compounds is electrospraying. This technique involves placing a large electrical potential (5-50 kV) between a conductive emitter needle and a grounded collector to electrically accelerate the solution. The high fields involved can create droplets smaller than a nebulizing nozzle and without the associated clogging issues. Further, this can be combined with an air stream for continuous powder collection similar to spray drying. Like spray drying, this technique has established control parameters to create particles of desired size and morphology (See Gao, Y. et al. Morphology control of electrosprayed core-shell particles via collection media variation. Materials Letters 146, 59-64 (2015), which is incorporated herein in its entirety by reference for all purposes). This technique similarly avoids high temperatures and so can be used with temperature sensitive cargo encapsulated within the silk fibroin.

### Silk Xerography for Personalized Medicine

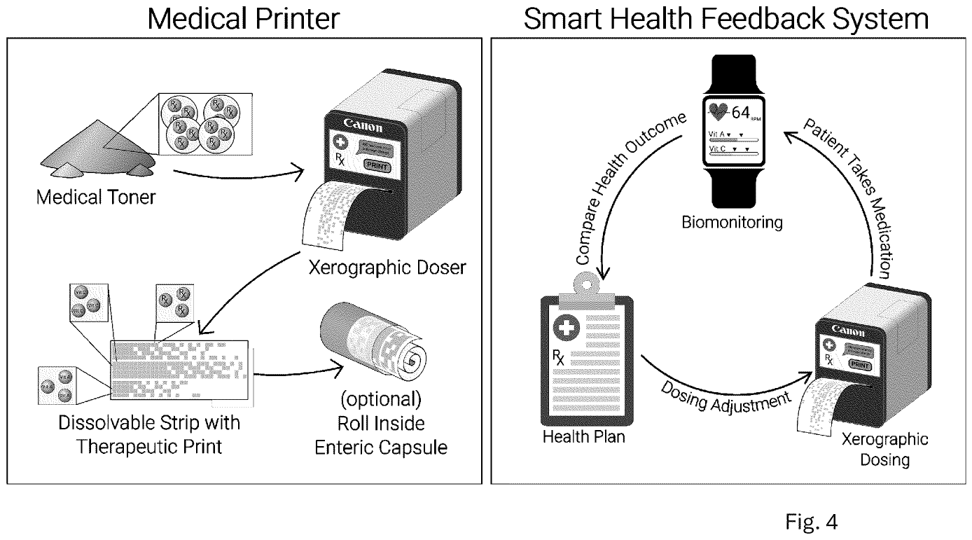

Each layer of a laser print deposits micrograms of toner per square centimeter and dosing can be controlled to an exquisitely fine degree with spatial coverage and multilayer deposition. One could conceive of this being used to help dose therapeutics on an as-need basis. With many people trying many kinds of diets, there are often micronutrient and vitamin deficiencies that occur from the exclusion of certain foods. These are often rectified by taking multi-vitamins, but this in turn comes with the risk of vitamin overdose, as these multivitamins often contain fat-soluble vitamins that can easily accumulate and cause harm through regular multivitamin consumption. In a data-driven health plan, vitamins and micronutrients can be tracked at home with either wearable or home-use sensors, but require the patient to constantly monitor and change dosages manually. This automated feedback loop can be closed by automating the dosing of vitamins by printing vitamin loaded fibroin onto consumable soluble films (FIG. 4). In this scheme a medical toner is made containing and stabilizing the medicinal compounds. This is loaded into a xerographic printer that doses these compounds onto an edible substrate. For vitamins this substrate could be eaten directly, but other compounds may be foul tasting or need to be protected from stomach acid, so this strip could be rolled and loaded into an enteric capsule for delivery.

Beyond vitamins the same scheme could be extended into drugs with narrow therapeutic windows, which are drugs that are efficacious very near the dosage they become toxic. These drugs are often those used to treat intractable diseases such as metastatic cancer and antibiotic resistant pathogens. Complicating dosage beyond merely the mass and blood volume of a patient is the fact that medicines are metabolized at different rates by different individuals. Even for two people of the same stature, one may find a dose ineffective while the other would suffer overdose effects from the same amount. This is currently handled by regular visits with a managing physician and numerous blood tests to slowly close in on the correct dosage. By carefully monitoring drug concentrations in the blood with a wearable device, the drug could be metered for every dose in order to maximize clinical effect while simultaneously minimizing side effects and dosage-based toxicity. This process would therefore allow medications dosages to be tailored to each patient's metabolism and response to the treatment.

While the market for laser printing of text documents is being eroded by the digital revolution, there are certain aspects of our life that cannot be digitized. Packaging, food, medical diagnostic devices and scientific assays will always be needed in physical form, but could also benefit from greener methods of manufacturing. Xerographic printing with silk fibroin offers an avenue to repurpose existing infrastructure and technical knowledge to tackle these problems in a way that is green and renewable. The unique properties of silk also enable the fabrication of futuristic medical devices that could fill the gap in the feedback cycle that currently separates constant diagnostic monitoring and tailored therapeutic delivery.

In addition to the features described above and elsewhere herein, the present disclosure also includes the following clauses:
1. A method of laser printing, the method comprising:
   xerographic printing, printing via patterns of electrostatic charge, and/or laser printing onto a substrate with a silk fibroin particle based toner comprising silk fibroin particles to produce a printed article.
2. The method of clause 1, wherein the laser printing sequentially comprises a first laser printing iteration with the silk fibroin particle based toner, a first intermediate printing iteration, and a second laser printing iteration with the silk firoin particle based toner.
3. The method of clause 2, wherein the laser printing further sequentially comprises, following the second laser printing iteration, a second intermediate printing iteration, and a third laser printing iteration with the silk fibroin particle based toner.
4. The method of any one of the preceding clauses, wherein the method further comprises printing a second biopolymer prior to or subsequent to the laser printing.
5. The method of any one of the preceding clauses, wherein the method comprises post-processing the silk fibroin particle based toner following the laser printing.
6. The method of any one of clauses 2 to the immediately preceding clause, wherein the first intermediate printing iteration comprises printing with a biopolymer ink comprising lignin, alginate, chitin, keratin, chitosan, or a combination thereof.
7. The method of any one of the preceding clauses, wherein the laser printing comprises setting and/or sintering the silk fibroin particles.
8. The method of the immediately preceding clause, wherein the setting and/or sintering
9. The method of any one of the preceding clauses, wherein the laser printing comprises curing, crosslinking, and/or recrystallizing the silk fibroin particles.
10. A dry bioprinting process comprising:
   selecting a bioprinting protein, a desired particle physical dimension, a desired particle electrostatic property, and optionally a desired particle residual moisture or a desired setting process (e.g., parameters to be utilized in a setting process); and
   laser printing with a bioprinting protein particle based toner onto a substrate to produce a printed article, the bioprinting protein particle based toner comprising bioprinting protein particles having the desired particle physical dimension, the desired particle electrostatic property, and optionally the desired particle residual moisture or the desired setting process.
11. The process of the immediately preceding clause, wherein the bioprinting protein is a structural protein, a globular protein, a fibrillar protein, an amphiphilic protein, or a combination thereof.
12. The process of the immediately preceding clause, wherein the bioprinting protein is albumin, sericin, collagen, casein, gluten, keratin, zein, or silk fibroin.
13. The process of the immediately preceding clause, wherein the bioprinting protein is silk fibroin.
14. The process of any one of clauses 9 to the immediately preceding clause, wherein the desired particle physical dimension is selected from a physical dimension disclosed in any one of US Pat. App. Pub. Nos. 2023/0039387 A1, 2023/0045444 A1, 2023/0051936 A1, 2023/0080900 A1, 2023/0091090 A1, 2023/0116451 A1, 2023/0117448 A1, 2023/0161277 A1, 2023/0176495 A1, Korean Patent No. 10-2517821 B1, each of which is incorporated herein in its entirety by reference for all purposes.
15. The process of the immediately preceding clause, wherein the desired particle physical dimension is between 1 μm and 10 μm or between 3 μm and 5 μm.
16. The process of any one of clauses 9 to the immediately preceding clause, wherein the desired particle electrostatic property is selected from an electrostatic property disclosed in any one of US Pat. App. Pub. Nos. 2023/0039387 A1, 2023/0045444 A1, 2023/0051936 A1, 2023/0080900 A1, 2023/0091090 A1, 2023/0116451 A1, 2023/0117448 A1, 2023/0161277 A1, 2023/0176495 A1, Korean Patent No. 10-2517821 B1, each of which is incorporated herein in its entirety by reference for all purposes.
17. The process of the immediately preceding clause, wherein the desired electrostatic property is dielectric.
18. The process of any one of clauses 9 to the immediately preceding clause, wherein the desired residual moisture is 20% or less, 15% or less, or 10% or less.
19. The process of any one of clauses 9 to the immediately preceding clause, wherein the laser printing comprises setting and/or sintering the bioprinting protein particles using the desired setting process.
20. The process of any one of clauses 9 to the immediately preceding clause, wherein the laser printing comprises curing, crosslinking, and/or recrystallizing the bioprinting protein particles.
21. A dry bioprinting process comprising:
   administering a bioprinting protein particle based toner comprising bioprinting protein particles to a substrate; and
   sintering the bioprinting protein particles.
22. The process of the immediately preceding clause, wherein the bioprinting protein is a structural protein, a globular protein, a fibrillar protein, an amphiphilic protein, or a combination thereof.
23. The process of the immediately preceding clause, wherein the bioprinting protein is silk fibroin.
24. The process of any one of clauses 19 to the immediately preceding clause, wherein the administering forms an image and the sintering sets the image.
25. The process of any one of clauses 19 to the immediately preceding clause, wherein the administering comprises xerography.
26. The process of any one of clauses 19 to the immediately preceding clause, wherein the sintering comprises contacting the bioprinting protein particles with water vapor.
27. The process of the immediately preceding clause, wherein the sintering comprises contacting the bioprinting protein particles with water vapor at two different water vapor temperatures.
28. The process of either of the two immediately preceding clauses, wherein the contacting the bioprinting protein particles with water vapor includes maintaining the bioprinting protein particles and the water vapor at a temperature of less than 75° C., less than 70° C., less than 65° C., less than 60° C., less than 55° C., or less than 50° C.
29. The process of any one of clauses 19 to the immediately preceding clause, the process further comprising curing, crosslinking, and/or recrystallizing the bioprinting protein particles.
30. A silk fibroin particle based toner comprising silk fibroin particles.
31. A laser printing cartridge loaded with silk fibroin particle based toner comprising silk fibroin particles.
32. The method, process, particle, or cartridge of any one of the preceding clauses, wherein the silk fibroin particle based toner further comprises filler fine particles.
33. The method, process, particle, or cartridge of the immediately preceding clause, wherein the filler fine particles comprise inorganic fine particles.
34. The method, process, particle, or cartridge of the immediately preceding clause, wherein the inorganic fine particles comprises silica, titania, alumina, or a combination thereof.
35. The method, process, particle, or cartridge of clause 30, wherein the filler fine particles comprise organic fine particles.
36. The method, process, particle, or cartridge of clause 30, wherein the filler fine particles comprise organic-inorganic composite fine particles.
37. The method, process, particle, or cartridge of any one of the preceding clauses, wherein a number average particle diameter of the silk fibroin particles is 20 nm or more and 1000 μm or less, including but not limited to, 1 μm or more and 10 μm or less, or 3 μm or more and 5 μm or less.
38. The method, process, particle, or cartridge of any one of the preceding clauses, wherein the silk fibroin particles have one or more physical property or physical dimension recited in any one of US Pat. App. Pub. Nos. 2023/0039387 A1, 2023/0045444 A1, 2023/0051936 A1, 2023/0080900 A1, 2023/0091090 A1, 2023/0116451 A1, 2023/0117448 A1, 2023/0161277 A1, 2023/0176495 A1, Korean Patent No. 10-2517821 B1, each of which is incorporated herein in its entirety by reference for all purposes.
39. The method, process, particle, or cartridge of any one of the preceding clauses, wherein the silk fibroin particles have one or more electrostatic property recited in any one of US Pat. App. Pub. Nos. 2023/0039387 A1, 2023/0045444 A1, 2023/0051936 A1, 2023/0080900 A1, 2023/0091090 A1, 2023/0116451 A1, 2023/0117448 A1, 2023/0161277 A1, 2023/0176495 A1, Korean Patent No. 10-2517821 B1, each of which is incorporated herein in its entirety by reference for all purposes.
40. The method, process, particle, or cartridge of any one of the preceding clauses, wherein the silk fibroin particles are formulated for printing as recited in any one of US Pat. App. Pub. Nos. 2023/0039387 A1, 2023/0045444 A1, 2023/0051936 A1, 2023/0080900 A1, 2023/0091090 A1, 2023/0116451 A1, 2023/0117448 A1, 2023/0161277 A1, 2023/0176495 A1, Korean Patent No. 10-2517821 B1, each of which is incorporated herein in its entirety by reference for all purposes.
41. The method, process, particle, or cartridge of any one of the preceding clauses, wherein the silk fibroin particles further comprise an additive.
42. The method, process, particle, or cartridge of any one of the preceding clauses, wherein the silk fibroin particles comprise a functional additive, wherein the functional additive is a selective protein, a fluorophore, a conductive material, a thermoreactive material, a sensing additive, a biologically active agent, or the like.
43. The method, process, particle, or cartridge of any one of the preceding clauses, wherein the silk fibroin particles comprise a medical diagnostic additive.
44. The method, process, particle, or cartridge of the immediately preceding clause, wherein the functional additive is covalently linked to the silk fibroin.
45. The method, process, particle, or cartridge of any one of the preceding clauses, wherein the silk fibroin particles and/or the bioprinting protein particles comprise one or more nutritional supplements.
46. The method, process, particle, or cartridge of either of the two immediately preceding clauses, wherein the functional additive is mixed with the silk fibroin within the silk fibroin particles.
47. The method, process, particle, or cartridge of any one of the preceding clauses, wherein the silk fibroin particles comprise a non-functional additive, wherein the non-functional additive is a non-selective protein, a colorant (e.g., a dye), an opacifying agent, an iridescent agent, a flavorant, an aroma, or the like.
48. The method, process, particle, or cartridge of any one of the preceding clauses, wherein the silk particles comprise a colorant, wherein the colorant is optionally a dye.
49. The method, process, particle, or cartridge of the immediately preceding clause, wherein the colorant is a naturally-occurring colorant, wherein the colorant is optionally anthocyanin.
50. The method, process, particle, or cartridge of any one of the preceding clauses, wherein the silk fibroin particles comprise silk fibroin that is at least partly sourced from recycled silk fabric.
51. The method, process, particle, or cartridge of any one of the preceding clauses, wherein the silk fibroin particles are made by spray drying.
52. The method, process, particle, or cartridge of any one of clauses 1-48, wherein the silk fibroin particles are made by lyophilization.
53. The method, process, particle, or cartridge of any one of clauses 1-48, wherein the silk fibroin particles are made by powdering.
54. The method, process, particle, or cartridge of any one of the preceding clauses, wherein the silk fibroin particles have a beta-sheet crystallinity degree of greater than 50% of a maximum achievable beta-sheet crystallinity degree.
55. The method, process, particle, or cartridge of any one of the preceding clauses, wherein the silk fibroin particles have a beta-sheet crystallinity degree of less than 50% of a maximum achievable beta-sheet crystallinity degree.
56. The method, process, particle, or cartridge of any one of the preceding clauses, wherein the silk fibroin particles have a minimum achievable beta-sheet crystallinity degree.
57. The method, process, particle, or cartridge of any one of the preceding clauses, wherein the substrate is a paper.
58. The method, process, particle, or cartridge of any one of the preceding clauses, wherein the substrate is a biodegradable substrate.
59. The method, process, particle, or cartridge of any one of the preceding clauses, wherein the substrate is an edible substrate.
60. The method, process, particle, or cartridge of any one of the preceding clauses, wherein the substrate comprises silk fibroin.
61. The method, process, particle, or cartridge of any one of the preceding clauses, wherein the silk fibroin particles or the bioprinting protein particles are non-porous.
62. The method or process of any one of the preceding clauses, the method comprising sintering the silk fibroin particles and/or the bioprinting protein particles.
63. The method or process of the immediately preceding clause, wherein sintering comprises applying heat to the silk fibroin particles and/or the bioprinting protein particles.
64. The method or process of the immediately preceding clause, wherein applying heat comprises a temperature of at least 40° C., at least 45° C., at least 50° C., at least 55° C., at least 60° C., at least 65° C., at least 70° C., at least 75° C., at least 80° C., at least 85° C., at least 90° C., or at least 95° C. and optionally at most 100° C.
65. The method or process of clause 59, wherein sintering comprises administering a protease to the silk fibroin particles and/or the bioprinting protein particles.
66. The method or process of clause 59, wherein sintering comprises applying pressure to the silk fibroin particles and/or the bioprinting protein particles.
67. The method or process of clause 59, wherein sintering comprises applying heat and pressure to the silk fibroin particles and/or the bioprinting protein particles.
68. The method or process of any one of the preceding clauses, the method further comprising activating the silk fibroin particle based toner and/or the bioprinting protein particle based toner by hydrating the silk fibroin particles and/or the bioprinting protein particles, wherein at least one property of the silk fibroin particle based toner and/or the bioprinting protein particle based toner is changed by the activating.
69. The method or process of any one of the preceding clauses, wherein the laser printing and/or dry bioprinting generates a personalized drug discovery platform.
70. The method or process of any one of clauses 1 to 26 or 30 to 65, wherein the laser printing and/or dry bioprinting generates a spatially-varying sensing platform.
71. The method or process of any one of clauses 1 to 26 or 30 to 65, wherein the laser printing and/or dry bioprinting generates a conductive pathway.
72. The method or process of any one of clauses 1 to 26 or 30 to 65, wherein the laser printing and/or dry bioprinting includes light-emitting compounds.
73. The method or process of any one of clauses 1 to 26 or 30 to 65, wherein the laser printing and/or dry bioprinting includes one or more lasing media.
74. The method or process of any one of clauses 1 to 26 or 30 to 65, wherein the laser printing and/or dry bioprinting includes one or more conductive molecules.
75. The method or process of any one of clauses 1 to 26 or 30 to 65, wherein the laser printing and/or dry bioprinting includes one or more photoconducting materials (e.g., perovskites).
76. The method or process of any one of clauses 1 to 26 or 30 to 65, wherein the laser printing and/or dry bioprinting includes a natural dye (e.g., anthocyanin).
77. The method or process of any one of clauses 1 to 26 or 30 to 65, wherein the printed article includes a physically unclonable function.
78. The method or process of any one of clauses 1 to 26 or 30 to 65, wherein the printed article is a cosmetic product (e.g., a makeup application patch or decal).
79. The method or process of any one of clauses 1 to 26 or 30 to 65, wherein the printed article is a facemask for application to a human face.
80. The method or process of any one of clauses 1 to 26 or 30 to 65, wherein the substrate is conformable to a skin surface.
81. The method or process of any one of clauses 1 to 26 or 30 to 65, wherein the printed article contains one or more alignment indicators for facilitating alignment during application.

1. A method of laser printing, the method comprising:
xerographic printing, printing via patterns of electrostatic charge, and/or laser printing onto a substrate with a silk fibroin particle based toner comprising silk fibroin particles to produce a printed article.

2. The method of claim 1, wherein the laser printing sequentially comprises a first laser printing iteration with the silk fibroin particle based toner, a first intermediate printing iteration, and a second laser printing iteration with the silk fibroin particle based toner.

3. The method of claim 2, wherein the laser printing further sequentially comprises, following the second laser printing iteration, a second intermediate printing iteration, and a third laser printing iteration with the silk fibroin particle based toner.

4. The method of claim 1, wherein the method further comprises printing a second biopolymer prior to or subsequent to the laser printing.

5. The method of claim 1, wherein the method comprises post-processing the silk fibroin particle based toner following the laser printing.

6. The method of claim 2, wherein the first intermediate printing iteration comprises printing with a biopolymer ink comprising lignin, alginate, chitin, keratin, chitosan, or a combination thereof.

7. The method of claim 1, wherein the laser printing comprises setting and/or sintering the silk fibroin particles.

8. The method of claim 7, wherein the setting and/or sintering comprises at least one of contacting the silk fibroin particles with water vapor. applying heat to the silk fibroin particles, administering a protease to the silk fibroin particles, applying a pressure to the silk fibroin particles, or applying heat and pressure to the silk fibroin particles.

9. The method of claim 1, wherein the laser printing comprises curing, crosslinking, and/or recrystallizing the silk fibroin particles.

10. A dry bioprinting process comprising:
selecting a bioprinting protein, a desired particle physical dimension, and a desired particle electrostatic property; and
laser printing with a bioprinting protein particle based toner onto a substrate to produce a printed article, the bioprinting protein particle based toner comprising bioprinting protein particles comprising the selected bioprinting protein having the desired particle physical dimension; and the desired particle electrostatic property.

11. The process of claim 10, wherein the bioprinting protein is a structural protein, a globular protein, a fibrillar protein, an amphiphilic protein, or a combination thereof.

12. The process of claim 10, wherein the bioprinting protein is albumin, sericin, collagen, casein, gluten, keratin, zein, or silk fibroin.

13. The process of the claim 12, wherein the bioprinting protein is silk fibroin.

14. A dry bioprinting process comprising:
administering a bioprinting protein particle based toner comprising bioprinting protein particles to a substrate; and
sintering the bioprinting protein particles.

15. The process of a claim 14, wherein the sintering comprises contacting the bioprinting protein particles with water vapor.

16. The process of claim 15, wherein the sintering comprises contacting the bioprinting protein particles with water vapor at two different water vapor temperatures.

17. The process of claim 15, wherein the contacting the bioprinting protein particles with water vapor includes maintaining the bioprinting protein particles and the water vapor at a temperature of less than 75° C., less than 70° C., less than 65° C., less than 60° C., less than 55° C., or less than 50° C.

18. The process of claim 14, the process further comprising curing, crosslinking, and/or recrystallizing the bioprinting protein particles.

19. A silk fibroin particle based toner comprising silk fibroin particles.

20. A laser printing cartridge loaded with silk fibroin particle based toner comprising silk fibroin particles.

21. The laser printing cartridge of claim 20, wherein the silk fibroin particle based toner further comprises filler fine particles.
